(19) United States
(12) Patent Application Publication
(10) Pub. No.: US 2026/0122645 A1
(43) Pub. Date: Apr. 30, 2026

(54) TRANSPORT BLOCK SEGMENTATION

(71) Applicant: QUALCOMM Incorporated, San Diego, CA (US)

(72) Inventors: Kirill IVANOV, La Jolla, CA (US); Wei YANG, San Diego, CA (US); Pinar SEN, San Diego, CA (US); Jing JIANG, San Diego, CA (US)

(21) Appl. No.: 18/929,381

(22) Filed: Oct. 28, 2024

(51) Int. Cl. H04W 72/23

(52) U.S. Cl. CPC H04W 72/23

(57) ABSTRACT

Methods, systems, and devices for wireless communications are described. A user equipment (UE) may receive a resource allocation for communication of a physical downlink shared channel (PDSCH) and may determine a quantity of code blocks associated with a transport block size of the PDSCH. In some implementations, the UE may adjust the quantity of code blocks to a second quantity of code blocks based on a quantity of time and frequency resources, a quantity of spatial layers, or both. In some implementations, the UE may adjust the quantity of code blocks to a second quantity of code blocks of a first size, to a third quantity of code blocks of a second size, or both based on a quantity of time and frequency resources, the quantity of code blocks, or both. The UE may communicate the second quantity of code blocks, the third quantity of code blocks, or both.

### TECHNICAL FIELD

The following relates to wireless communications, including transport block segmentation.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The systems, methods, and devices of this disclosure each have several innovative aspects, no single one of which is solely responsible for the desirable attributes disclosed herein.

A method for wireless communications by a user equipment (UE) is described. The method may include receiving control information including a resource allocation for communication of a physical downlink shared channel (PDSCH), determining a first quantity of code blocks (CBs) associated with a transport block size (TBS) of the PDSCH, where the TBS is based on the resource allocation, adjusting the first quantity of CBs to a second quantity of CBs based on a quantity of time and frequency resources allocated for the PDSCH, a quantity of spatial layers associated with the communication of the PDSCH, or both, and communicating, via the quantity of time and frequency resources using the quantity of spatial layers, the second quantity of CBs in accordance with adjusting the first quantity of CBs to the second quantity of CBs.

A UE for wireless communications is described. The UE may include one or more memories storing processor executable code, and one or more processors coupled with (e.g., operatively, communicatively, functionally, electronically, or electrically) the one or more memories. The one or more processors may individually or collectively be operable to execute the code (e.g., directly, indirectly, after pre-processing, without pre-processing) to cause the UE to receive control information including a resource allocation for communication of a PDSCH, determine a first quantity of CBs associated with a TBS of the PDSCH, where the TBS is based on the resource allocation, adjust the first quantity of CBs to a second quantity of CBs based on a quantity of time and frequency resources allocated for the PDSCH, a quantity of spatial layers associated with the communication of the PDSCH, or both, and communicate, via the quantity of time and frequency resources using the quantity of spatial layers, the second quantity of CBs in accordance with adjusting the first quantity of CBs to the second quantity of CBs.

Another UE for wireless communications is described. The UE may include means for receiving control information including a resource allocation for communication of a PDSCH, means for determining a first quantity of CBs associated with a TBS of the PDSCH, where the TBS is based on the resource allocation, means for adjusting the first quantity of CBs to a second quantity of CBs based on a quantity of time and frequency resources allocated for the PDSCH, a quantity of spatial layers associated with the communication of the PDSCH, or both, and means for communicating, via the quantity of time and frequency resources using the quantity of spatial layers, the second quantity of CBs in accordance with adjusting the first quantity of CBs to the second quantity of CBs.

A non-transitory computer-readable medium storing code for wireless communications is described. The code may include instructions executable by one or more processors (e.g., directly, indirectly, after pre-processing, without pre-processing) to receive control information including a resource allocation for communication of a PDSCH, determine a first quantity of CBs associated with a TBS of the PDSCH, where the TBS is based on the resource allocation, adjust the first quantity of CBs to a second quantity of CBs based on a quantity of time and frequency resources allocated for the PDSCH, a quantity of spatial layers associated with the communication of the PDSCH, or both, and communicate, via the quantity of time and frequency resources using the quantity of spatial layers, the second quantity of CBs in accordance with adjusting the first quantity of CBs to the second quantity of CBs.

In some examples of the method, UEs, and non-transitory computer-readable medium described herein, adjusting the first quantity of CBs may include operations, features, means, or instructions for decreasing the first quantity of CBs to the second quantity of CBs such that the quantity of time and frequency resources allocated for the PDSCH evenly divides a combination of the second quantity of CBs and the quantity of spatial layer associated with the communication of the PDSCH.

In some examples of the method, UEs, and non-transitory computer-readable medium described herein, adjusting the first quantity of CBs may include operations, features, means, or instructions for decreasing the first quantity of CBs to a third quantity of CBs and increasing, based on the third quantity of CBs failing to satisfy a threshold, the first quantity of CBs to the second quantity of CBs such that the quantity of time and frequency resources allocated for the PDSCH evenly divides a combination of the second quantity of CBs and the quantity of spatial layers associated with the communication of the PDSCH.

Some examples of the method, UEs, and non-transitory computer-readable medium described herein may further include operations, features, means, or instructions for determining a quantity of information bits associated with the PDSCH based on a quantity of resource elements associated with the PDSCH, a coding rate associated with the PDSCH, a modulation order associated with the PDSCH, the quantity of spatial layers, or a combination thereof and determining the TBS based on the quantity of information bits, the coding rate, or both, where determining the first quantity of CBs may be based on determining the TBS.

In some examples of the method, UEs, and non-transitory computer-readable medium described herein, the coding rate may be indicated via the resource allocation.

In some examples of the method, UEs, and non-transitory computer-readable medium described herein, the coding rate may be a fixed coding rate value and determining the quantity of information bits and the TBS may be based on the fixed coding rate value.

In some examples of the method, UEs, and non-transitory computer-readable medium described herein, communicating the second quantity of CBs may include operations, features, means, or instructions for communicating each CB part of the second quantity of CBs via the single orthogonal frequency division multiplexing (OFDM) symbol.

In some examples of the method, UEs, and non-transitory computer-readable medium described herein, each CB part of a respective CB of the second quantity of CBs may be transmitted via a respective spatial layer of the quantity of spatial layers and at a respective time within the single OFDM symbol.

In some examples of the method, UEs, and non-transitory computer-readable medium described herein, communicating the second quantity of CBs may include operations, features, means, or instructions for communicating at least a first CB part of a first CB of the second quantity of CBs via a first OFDM symbol the two or more OFDM symbols and communicating at least a second CB part of the first CB via a second OFDM symbol of the two or more OFDM symbols.

Some examples of the method, UEs, and non-transitory computer-readable medium described herein may further include operations, features, means, or instructions for communicating at least the first CB part of the first CB via a first spatial layer of the quantity of spatial layers and communicating at least the second CB part of the first CB via a second spatial layer of the quantity of spatial layers.

A method for wireless communications by a UE is described. The method may include receiving control information including a resource allocation for communication of a PDSCH, determining a first quantity of CBs associated with a TBS of the PDSCH, where the TBS is based on the resource allocation, adjusting the first quantity of CBs to a second quantity of CBs of a first size, to a third quantity of CBs of a second size that is less than the first size, or both based on a quantity of time and frequency resources allocated for the PDSCH, on the first quantity of CBs, or both, and communicating, via the quantity of time and frequency resources using a set of multiple spatial layers, the second quantity of CBs, the third quantity of CBs, or both in accordance with determining the second quantity of CBs and determining the third quantity of CBs.

A UE for wireless communications is described. The UE may include one or more memories storing processor executable code, and one or more processors coupled with (e.g., operatively, communicatively, functionally, electronically, or electrically) the one or more memories. The one or more processors may individually or collectively be operable to execute the code (e.g., directly, indirectly, after pre-processing, without pre-processing) to cause the UE to receive control information including a resource allocation for communication of a PDSCH, determine a first quantity of CBs associated with a TBS of the PDSCH, where the TBS is based on the resource allocation, adjust the first quantity of CBs to a second quantity of CBs of a first size, to a third quantity of CBs of a second size that is less than the first size, or both based on a quantity of time and frequency resources allocated for the PDSCH, on the first quantity of CBs, or both, and communicate, via the quantity of time and frequency resources using a set of multiple spatial layers, the second quantity of CBs, the third quantity of CBs, or both in accordance with determining the second quantity of CBs and determining the third quantity of CBs.

Another UE for wireless communications is described. The UE may include means for receiving control information including a resource allocation for communication of a PDSCH, means for determining a first quantity of CBs associated with a TBS of the PDSCH, where the TBS is based on the resource allocation, means for adjusting the first quantity of CBs to a second quantity of CBs of a first size, to a third quantity of CBs of a second size that is less than the first size, or both based on a quantity of time and frequency resources allocated for the PDSCH, on the first quantity of CBs, or both, and means for communicating, via the quantity of time and frequency resources using a set of multiple spatial layers, the second quantity of CBs, the third quantity of CBs, or both in accordance with determining the second quantity of CBs and determining the third quantity of CBs.

A non-transitory computer-readable medium storing code for wireless communications is described. The code may include instructions executable by one or more processors (e.g., directly, indirectly, after pre-processing, without pre-processing) to receive control information including a resource allocation for communication of a PDSCH, determine a first quantity of CBs associated with a TBS of the PDSCH, where the TBS is based on the resource allocation, adjust the first quantity of CBs to a second quantity of CBs of a first size, to a third quantity of CBs of a second size that is less than the first size, or both based on a quantity of time and frequency resources allocated for the PDSCH, on the first quantity of CBs, or both, and communicate, via the quantity of time and frequency resources using a set of multiple spatial layers, the second quantity of CBs, the third quantity of CBs, or both in accordance with determining the second quantity of CBs and determining the third quantity of CBs.

In some examples of the method, UEs, and non-transitory computer-readable medium described herein, communicating the second quantity of CBs, the third quantity of CBs, or both may include operations, features, means, or instructions for communicating the second quantity of CBs prior to the third quantity of CBs in time based on the first size of the second quantity of CBs being greater than the second size of the third quantity of CBs.

Some examples of the method, UEs, and non-transitory computer-readable medium described herein may further include operations, features, means, or instructions for adjusting the first quantity of CBs to the second quantity of CBs, to the third quantity of CBs, and to a fourth quantity of CBs of a third size based on the first quantity of CBs, the quantity of time and frequency resources, or both, where the third size may be less than the first size and greater than the second size and communicating, via the quantity of time and frequency resources using a set of multiple spatial layers, the fourth quantity of CBs in accordance with the adjusting.

Some examples of the method, UEs, and non-transitory computer-readable medium described herein may further include operations, features, means, or instructions for determining a quantity of information bits associated with the PDSCH based on a quantity of resource elements associated with the PDSCH, a coding rate associated with the PDSCH, a modulation order associated with the PDSCH, the quantity of spatial layers, or a combination thereof and determining the TBS based on the quantity of information bits, the coding rate, or both, where determining the first quantity of CBs may be based on determining the TBS.

In some examples of the method, UEs, and non-transitory computer-readable medium described herein, the communicating may include operations, features, means, or instructions for communicating each CB part of the second quantity of CBs, each CB part of the third quantity of CBs, or both via the single OFDM symbol.

In some examples of the method, UEs, and non-transitory computer-readable medium described herein, each CB part of a respective CB of the second quantity of CBs may be transmitted via a respective spatial layer of the quantity of spatial layers and at a respective time within the single OFDM symbol, each CB part of a respective CB of the third quantity of CBs may be transmitted via a respective spatial layer of the quantity of spatial layers and at a respective time within the single OFDM symbol, or both.

In some examples of the method, UEs, and non-transitory computer-readable medium described herein, the communicating may include operations, features, means, or instructions for communicating each CB part of a first CB of the second quantity of CBs via the two or more OFDM symbols, where one or more CB parts of the first CB may be communicated within a respective OFDM symbol of the two or more OFDM symbols and communicating each CB part of a first CB of the third quantity of CBs via the two or more OFDM symbols, where one or more CB parts of the first CB may be communicated via a respective OFDM symbol of the two or more OFDM symbols.

In some examples of the method, UEs, and non-transitory computer-readable medium described herein, communicating the second quantity of CBs may include operations, features, means, or instructions for communicating at least a first CB part of the first CB of the second quantity of CBs via a first spatial layer of the quantity of spatial layers and via a first OFDM symbol of the two or more OFDM symbols and communicating at least a second CB part of the first CB of the second quantity of CBs via a second spatial layer of the quantity of spatial layers and via a second OFDM symbol of the two or more OFDM symbols.

In some examples of the method, UEs, and non-transitory computer-readable medium described herein, communicating the third quantity of CBs may include operations, features, means, or instructions for communicating at least a first CB part of the first CB of the third quantity of CBs via a first spatial layer of the quantity of spatial layers and via a first OFDM symbol of the two or more OFDM symbols and communicating at least a second CB part of the first CB of the third quantity of CBs via a second spatial layer of the quantity of spatial layers and via a second OFDM symbol of the two or more OFDM symbols.

In some examples of the method, UEs, and non-transitory computer-readable medium described herein, the second quantity of CBs may be greater than the third quantity of CBs.

In some examples of the method, UEs, and non-transitory computer-readable medium described herein, the first size of the second quantity of CBs includes a first quantity of information bits, the second size of the third quantity of CBs includes a second quantity of information bits, and the first quantity of information bits may be greater than the second quantity of information bits.

Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIGS. 1 and 2 show examples of wireless communications systems that support transport block segmentation in accordance with one or more aspects of the present disclosure.

FIGS. 3 and 4 show examples of code block (CB) diagrams that support transport block segmentation in accordance with one or more aspects of the present disclosure.

FIG. 5 shows an example of a process flow that supports transport block segmentation in accordance with one or more aspects of the present disclosure.

FIGS. 6 and 7 show block diagrams of devices that support transport block segmentation in accordance with one or more aspects of the present disclosure.

FIG. 8 shows a block diagram of a communications manager that supports transport block segmentation in accordance with one or more aspects of the present disclosure.

FIG. 9 shows a diagram of a system including a device that supports transport block segmentation in accordance with one or more aspects of the present disclosure.

FIGS. 10 and 11 show flowcharts illustrating methods that support transport block segmentation in accordance with one or more aspects of the present disclosure.

### DETAILED DESCRIPTION

In some wireless communications systems, a transmitting wireless device (e.g., user equipment (UE) or network entity) and a receiving wireless device (e.g., network entity or UE) may support spatially coupled multiple input-multiple output (SC-MIMO) communication. For example, in SC-MIMO, a wireless device (e.g., transmitting wireless device, receiving wireless device) may partition one or more transport blocks (e.g., codewords (CWs), user data) into multiple code blocks (CBs) for communication, where the wireless device may further partition each CB into one or more CB parts. Accordingly, the wireless device may map each CB to a respective spatial layer (e.g., communicated using various antenna ports or DMRS ports of the wireless device) and a respective time and frequency resource, such that the wireless device transmits or receives each CB part of a CB via a respective spatial layer and a respective time and frequency resource.

To facilitate such SC-MIMO communications, the wireless device may partition the transport block into multiple CBs of equal or similar sizes (e.g., a same bit length), such that sizes of the CB parts of different CBs may also be similar in size. By doing so, the wireless device may map the CB parts of different CBs to same time resource across different spatial layers, thereby ensuring alignment during transmission of the CB parts. In some cases, however, the partition of the transport block into multiple CBs may result in uneven CBs or CBs of different sizes, thereby ensuring that each CB part size may be different. Such uneven CBs may not be compatible with the SC-MIMO diagonal transmission structure, which may increase latency during such SC-MIMO communications, among other disadvantages.

The techniques described herein may enable the wireless device to partition a transport block into multiple CBs of equal or similar sizes by adjusting the quantity of CBs a transport block is divided into or by adjusting the quantity of CBs of different sizes. Partitioning the transport block into multiple CBs of equal or similar size may enable the wireless device to use SC-MIMO, which may increase diversity of transmissions and increase throughput, leading to decreased latency and improved communication quality.

In some implementations, based on receiving a resource allocation for a physical downlink shared channel (PDSCH) and determining a first quantity of CBs based on a transport block size (TBS) of the PDSCH, a UE may adjust the first quantity of CBs to a second quantity of CBs, such that a quantity of time and frequency resources allocated for the PDSCH may evenly divide a combination of the second quantity of CBs and a quantity of spatial layers associated with communicating the PDSCH. In some examples, the UE may decrease the first quantity of CBs to the second quantity of CBs such that the quantity of time and frequency resources allocated for the PDSCH evenly divides the combination of the second quantity of CBs and a quantity of spatial layers (e.g., spatial resources, layer blocks) associated with the communication of the PDSCH, which may ensure that the CBs are the same size, thereby enabling the CB parts of such CBs to be a same size. Alternatively, the UE may increase the first quantity of CBs to a second quantity of CBs such that a quantity of time and frequency resources allocated for the PDSCH evenly divides a combination of the second quantity of CBs and a quantity of spatial resources associated with the communication of the PDSCH. By ensuring that the quantity of time and frequency resources allocated for the PDSCH evenly divides the combination, the UE may ensure that each CB of the second quantity of CB has a same size.

In some other implementations, based on receiving a resource allocation for a PDSCH and determining a first quantity of CBs based on a TBS of the PDSCH transmission, the UE may maintain the first quantity of CBs as a total quantity of CBS, but may divide the first quantity of CBs into a second quantity of CBs of a first size and a third quantity of CBs of a second size. The first size and the second size may be similar enough that the diagonal structure of SC-MIMO may support the slight difference in size, or the CB parts of each CB may be stacked to align the different sizes of CB parts. In some cases, the UE may also include a fourth quantity of CBs of a third size, the third size between the first size and the second size. In this way, the multiple CBs may be communicated in accordance with the diagonal SC-MIMO structure.

Aspects of the disclosure are initially described in the context of wireless communications systems, CB diagrams, and process flows. Aspects of the disclosure are further illustrated by and described with reference to apparatus diagrams, system diagrams, and flowcharts that relate to transport block segmentation.

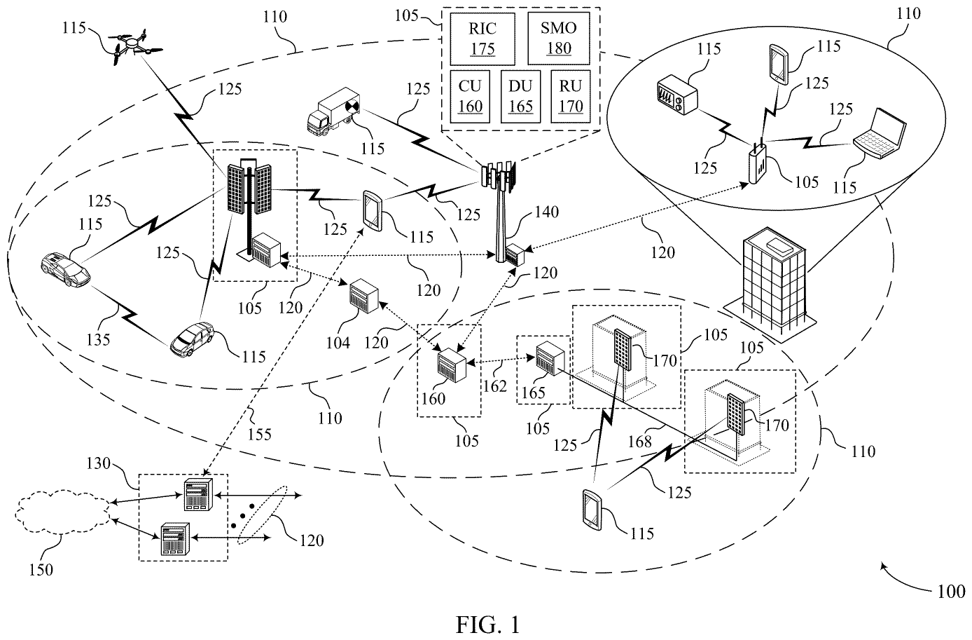

FIG. 1 shows an example of a wireless communications system 100 that supports transport block segmentation in accordance with one or more aspects of the present disclosure. The wireless communications system 100 may include one or more devices, such as one or more network devices (e.g., network entities 105), one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via communication link(s) 125 (e.g., a radio frequency (RF) access link). For example, a network entity 105 may support a coverage area 110 (e.g., a geographic coverage area) over which the UEs 115 and the network entity 105 may establish the communication link(s) 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices in the wireless communications system 100 (e.g., other wireless communication devices, including UEs 115 or network entities 105), as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with a core network 130, or with one another, or both. For example, network entities 105 may communicate with the core network 130 via backhaul communication link(s) 120 (e.g., in accordance with an S1, N2, N3, or other interface protocol). In some examples, network entities 105 may communicate with one another via backhaul communication link(s) 120 (e.g., in accordance with an X2, Xn, or other interface protocol) either directly (e.g., directly between network entities 105) or indirectly (e.g., via the core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication link(s) 120, midhaul communication links 162, or fronthaul communication links 168 may be or include one or more wired links (e.g., an electrical link, an optical fiber link) or one or more wireless links (e.g., a radio link, a wireless optical link), among other examples or various combinations thereof. A UE 115 may communicate with the core network 130 via a communication link 155.

One or more of the network entities 105 or network equipment described herein may include or may be referred to as a base station 140 (e.g., a base transceiver station, a radio base station, an NR base station, an access point, a radio transceiver, a NodeB, an eNodeB (eNB), a next-generation NodeB or giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within one network entity (e.g., a network entity 105 or a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among multiple network entities (e.g., network entities 105), such as an integrated access and backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU), such as a CU 160, a distributed unit (DU), such as a DU 165, a radio unit (RU), such as an RU 170, a RAN Intelligent Controller (RIC), such as an RIC 175 (e.g., a Near-Real Time RIC (Near-RT RIC), a Non-Real Time RIC (Non-RT RIC)), a Service Management and Orchestration (SMO) system, such as an SMO system 180, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more of the network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, or any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaptation protocol (SDAP), Packet Data Convergence Protocol (PDCP)). The CU 160 (e.g., one or more CUs) may be connected to a DU 165 (e.g., one or more DUs) or an RU 170 (e.g., one or more RUs), or some combination thereof, and the DUs 165, RUs 170, or both may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or multiple different RUs, such as an RU 170). In some cases, a functional split between a CU 160 and a DU 165 or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to a DU 165 via a midhaul communication link 162 (e.g., F1, F1-c, F1-u), and a DU 165 may be connected to an RU 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities (e.g., one or more of the network entities 105) that are in communication via such communication links.

In some wireless communications systems (e.g., the wireless communications system 100), infrastructure and spectral resources for radio access may support wireless backhaul link capabilities to supplement wired backhaul connections, providing an IAB network architecture (e.g., to a core network 130). In some cases, in an IAB network, one or more of the network entities 105 (e.g., network entities 105 or IAB node(s) 104) may be partially controlled by each other. The IAB node(s) 104 may be referred to as a donor entity or an IAB donor. A DU 165 or an RU 170 may be partially controlled by a CU 160 associated with a network entity 105 or base station 140 (such as a donor network entity or a donor base station). The one or more donor entities (e.g., IAB donors) may be in communication with one or more additional devices (e.g., IAB node(s) 104) via supported access and backhaul links (e.g., backhaul communication link(s) 120). IAB node(s) 104 may include an IAB mobile termination (IAB-MT) controlled (e.g., scheduled) by one or more DUs (e.g., DUs 165) of a coupled IAB donor. An IAB-MT may be equipped with an independent set of antennas for relay of communications with UEs 115 or may share the same antennas (e.g., of an RU 170) of IAB node(s) 104 used for access via the DU 165 of the IAB node(s) 104 (e.g., referred to as virtual IAB-MT (vIAB-MT)). In some examples, the IAB node(s) 104 may include one or more DUs (e.g., DUs 165) that support communication links with additional entities (e.g., IAB node(s) 104, UEs 115) within the relay chain or configuration of the access network (e.g., downstream). In such cases, one or more components of the disaggregated RAN architecture (e.g., the IAB node(s) 104 or components of the IAB node(s) 104) may be configured to operate according to the techniques described herein.

In the case of the techniques described herein applied in the context of a disaggregated RAN architecture, one or more components of the disaggregated RAN architecture may be configured to support transport block segmentation as described herein. For example, some operations described as being performed by a UE 115 or a network entity 105 (e.g., a base station 140) may additionally, or alternatively, be performed by one or more components of the disaggregated RAN architecture (e.g., components such as an IAB node, a DU 165, a CU 160, an RU 170, an RIC 175, an SMO system 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a multimedia/entertainment device (e.g., a radio, a MP3 player, or a video device), a camera, a gaming device, a navigation/positioning device (e.g., GNSS (global navigation satellite system) devices based on, for example, GPS (global positioning system), Beidou, GLONASS, or Galileo, or a terrestrial-based device), a tablet computer, a laptop computer, a netbook, a smartbook, a personal computer, a smart device, a wearable device (e.g., a smart watch, smart clothing, smart glasses, virtual reality goggles, a smart wristband, smart jewelry (e.g., a smart ring, a smart bracelet)), a drone, a robot/robotic device, a vehicle, a vehicular device, a meter (e.g., parking meter, electric meter, gas meter, water meter), a monitor, a gas pump, an appliance (e.g., kitchen appliance, washing machine, dryer), a location tag, a medical/healthcare device, an implant, a sensor/actuator, a display, or any other suitable device configured to communicate via a wireless or wired medium. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, vehicles, or meters, among other examples.

In an aspect, techniques disclosed herein may be applicable to MTC or IoT UEs. MTC or IoT UEs may include MTC/enhanced MTC (eMTC, also referred to as CAT-M, Cat M1) UEs, NB-IoT (also referred to as CAT NB1) UEs, as well as other types of UEs. eMTC and NB-IoT may refer to future technologies that may evolve from or may be based on these technologies. For example, eMTC may include FeMTC (further eMTC), eFeMTC (enhanced further eMTC), and mMTC (massive MTC), and NB-IoT may include eNB-IoT (enhanced NB-IoT), and FeNB-IoT (further enhanced NB-IoT).

The UEs 115 described herein may be able to communicate with various types of devices, such as UEs 115 that may sometimes operate as relays, as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via the communication link(s) 125 (e.g., one or more access links) using resources associated with one or more carriers. The term “carrier” may refer to a set of RF spectrum resources having a defined PHY layer structure for supporting the communication link(s) 125. For example, a carrier used for the communication link(s) 125 may include a portion of an RF spectrum band (e.g., a bandwidth part (BWP)) that is operated according to one or more PHY layer channels for a given RAT (e.g., LTE, LTE-A, LTE-A Pro, NR). Each PHY layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities, such as one or more of the network entities 105).

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems, such as the wireless communications system 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (STTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to UEs 115 (e.g., one or more UEs) or may include UE-specific search space sets for sending control information to a UE 115 (e.g., a specific UE).

In some examples, a network entity 105 (e.g., a base station 140, an RU 170) may be movable and therefore provide communication coverage for a moving coverage area, such as the coverage area 110. In some examples, coverage areas 110 (e.g., different coverage areas) associated with different technologies may overlap, but the coverage areas 110 (e.g., different coverage areas) may be supported by the same network entity (e.g., a network entity 105). In some other examples, overlapping coverage areas, such as a coverage area 110, associated with different technologies may be supported by different network entities (e.g., the network entities 105). The wireless communications system 100 may include, for example, a heterogeneous network in which different types of the network entities 105 support communications for coverage areas 110 (e.g., different coverage areas) using the same or different RATs.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs (e.g., one or more of the UEs 115) via a device-to-device (D2D) communication link, such as a D2D communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1: M) system in which each UE 115 transmits to one or more of the UEs 115 in the group. In some examples, a network entity 105 may facilitate the scheduling of resources for D2D communications. In some other examples, D2D communications may be carried out between the UEs 115 without an involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than one hundred kilometers) compared to communications using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) RAT, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

The network entities 105 or the UEs 115 may use MIMO communications to exploit multipath signal propagation and increase spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry information associated with the same data stream (e.g., the same CW) or different data streams (e.g., different CWs). Different spatial layers may be associated with different antenna ports used for channel measurement and reporting. MIMO techniques include single-user MIMO (SU-MIMO), for which multiple spatial layers are transmitted to the same receiving device, and multiple-user MIMO (MU-MIMO), for which multiple spatial layers are transmitted to multiple devices.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

The wireless communications system 100 may be a packet-based network that operates according to a layered protocol stack. In the user plane, communications at the bearer or PDCP layer may be IP-based. An RLC layer may perform packet segmentation and reassembly to communicate via logical channels. A MAC layer may perform priority handling and multiplexing of logical channels into transport channels. The MAC layer also may implement error detection techniques, error correction techniques, or both to support retransmissions to improve link efficiency. In the control plane, an RRC layer may provide establishment, configuration, and maintenance of an RRC connection between a UE 115 and a network entity 105 or a core network 130 supporting radio bearers for user plane data. A PHY layer may map transport channels to physical channels.

In some wireless communications systems 100, a transmitting wireless device (e.g., UE 115 or network entity 105) and receiving wireless device (e.g., UE 115 or network entity 105) may support spatially coupled multiple input-multiple output (SC-MIMO) communication. For example, in SC-MIMO, a UE 115 may partition one or more transport blocks (e.g., CWs, user data) into multiple CBs for communication, where the UE 115 may further partition each CB into one or more CB parts. Accordingly, the UE 115 may map each CB to respective spatial layer (e.g., communicated using various antenna ports or DMRS ports of the wireless device) and a respective time and frequency resource, such that the UE 115 transmits each CB part of a CB via a respective spatial layer and a respective time and frequency resource.

To facilitate such SC-MIMO communications, the UE 115 may partition the transport block into multiple CBs of equal or similar sizes (e.g., a same bit length), such that sizes of the CB parts of different CBs may also be similar in size. By doing so, the UE 115 may map the CB parts of different CBs to same time resource across different spatial layers, thereby ensuring alignment during transmission of the CB parts. In some cases, however, the partition of the transport block into multiple CBs may result in uneven CBs or CBs of different sizes, thereby ensuring that each CB part size may be different. Such uneven CBs may not be compatible with the SC-MIMO diagonal transmission structure, which may increase latency during such SC-MIMO communications, among other disadvantages.

In some wireless communications systems 100, the UE 115 may partition a transport block into multiple CBs of equal or similar sizes by adjusting the quantity of CBs a transport block is divided into or by adjusting the quantity of CBs of different sizes. Partitioning the transport block into multiple CBs of equal or similar size may enable the transmitting wireless device to use SC-MIMO, which may increase diversity of transmissions and increase throughput, leading to decreased latency and improved communication quality.

In some implementations, based on receiving a resource allocation for a PDSCH and determining a first quantity of CBs based on a TBS of the PDSCH, the UE 115 may adjust the first quantity of CBs to a second quantity of CBs, such that a quantity of time and frequency resources allocated for the PDSCH may evenly divide a combination of the second quantity of CBs and a quantity of spatial layers associated with communicating the PDSCH. In some examples, the UE 115 may decrease the first quantity of CBs to the second quantity of CBs such that the quantity of time and frequency resources allocated for the PDSCH evenly divides the combination of the second quantity of CBs and a quantity of spatial layers (e.g., spatial resources, layer blocks) associated with the communication of the PDSCH, which may ensure that the CBs are the same size, thereby enabling the CB parts of such CBs to be a same size.

Alternatively, the UE 115 may increase the first quantity of CBs to a second quantity of CBs such that a quantity of time and frequency resources allocated for the PDSCH evenly divides a combination of the second quantity of CBs and a quantity of spatial resources associated with the communication of the PDSCH. By ensuring that the quantity of time and frequency resources allocated for the PDSCH evenly divides the combination, the UE 115 may ensure that each CB of the second quantity of CB has a same size.

In some other implementations, based on receiving a resource allocation for a PDSCH and determining a first quantity of CBs based on a TBS of the PDSCH transmission, the UE 115 may maintain the first quantity of CBs as a total quantity of CBs, but may divide the first quantity of CBs into a second quantity of CBs of a first size and a third quantity of CBs of a second size. The first size and the second size may be similar enough that the diagonal structure of SC-MIMO may support the slight difference in size, or the CB parts of each CB may be stacked to align the different sizes of CB parts. In some cases, the UE 115 may also include a fourth quantity of CBs of a third size, the third size between the first size and the second size. In this way, the multiple CBs may be communicated in accordance with the diagonal SC-MIMO structure.

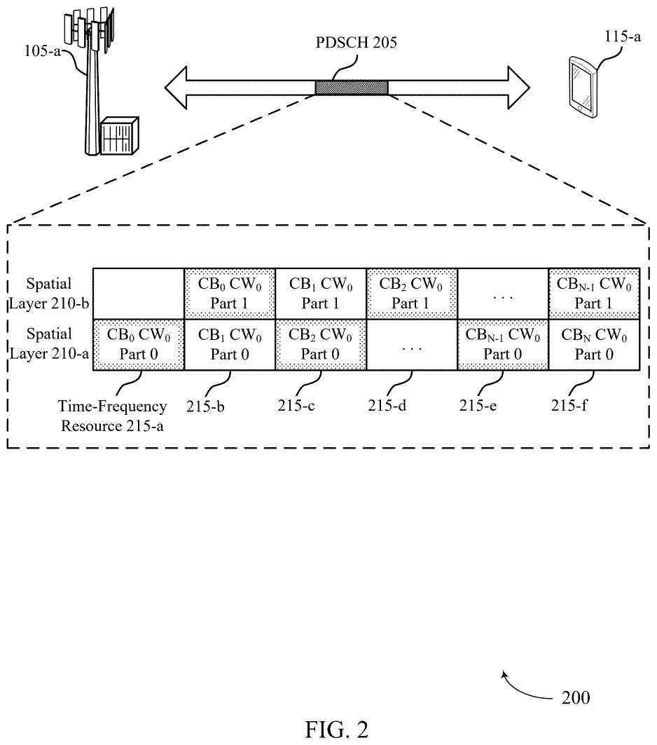

FIG. 2 shows an example of a wireless communications system 200 that supports transport block (e.g., CW) segmentation in accordance with one or more aspects of the present disclosure. For example, the wireless communications system 200 may include a UE 115-a and a network entity 105-a, which may be examples of the corresponding devices as described herein, including with reference to FIG. 1. The techniques described in the context of the wireless communications system 200 may enable the UE 115-a to adjust CW segmentation in order to support SC-MIMO.

Some wireless communications systems 200 (e.g., LTE) may support a dual CW (e.g., transport block) MIMO design structure. In dual CW MIMO, different CWs (e.g., transport blocks) may be assigned to different spatial layers 210, where the CWs may be divided into CBs and each CB for a CW may be transmitted in a different time-frequency resource 215 using the spatial layer 210. For example, a first CW may be mapped to a first spatial layer 210 and a second CW may be mapped to a second spatial layer 210. In such examples, the network entity 105-a (e.g., the UE 115-a) may transmit a first CB of the first CW via a first time and frequency resource 215 and transmit a second CB of the first CW via a second time and frequency resource 215, while also transmitting a first CB of the second CW via the first time and frequency resource 215 and transmitting a second CB of the second CW via the second time and frequency resource 215. In dual CW MIMO, CWs may be assigned different rates and hard successive interference cancellation (SIC) may be applied to the CWs. In some examples, the CWs may be accurate according to channel quality index (CQI).

Some wireless communications systems 200 (e.g., NR) may support a single CW MIMO design, which may include an irregular low density parity check (LDPC) code. In single CW MIMO, CBs of CWs may be mapped vertically to different spatial layers, or may be repeated on multiple spatial layers. For example, the network entity 105-a (e.g., the UE 115-a) may transmit a first CB of a first CW via both a first spatial layer 210 and a second spatial layer 210 and via a first time-frequency resource 215 and transmit a second CB of the first CW via the first spatial layer 210-a and the second spatial layer 210-b and via a second time-frequency resource 215. In some cases, the UE 115-a (e.g., the network entity 105-a) may implement single CW MIMO with iterative demodulation or decoding across the multiple spatial layers 210 in order to improve performance. In some cases, LDPC schemes may not be suitable for iterative demodulation or decoding.

Some wireless communication systems 200 may support SC-MIMO. SC-MIMO may be an example of a single CW design with spatial coupling, such as diagonal layering (e.g., D-BLAST type). That is, in SC-MIMO, a network entity 105-a may divide CWs into multiple CBS and dived each CB into CB parts. Accordingly, the network entity 105-a may map each CB part of a CB to a respective spatial layer 210 of a MIMO data transmission, such as PDSCH 205, in a staggered manner, such as diagonally across time-frequency resources 215. In some cases, the quantity of CB parts may be the same as the quantity of spatial layers 210.

For example, a CW₀ may be divided (e.g., by the network entity 105-a) into N CBs (e.g., CB₀ through CB_{N}), where each CB may be divided (e.g., partitioned) into two parts (e.g., Part 0 and Part 1). Accordingly, to transmit CB₀ of CW₀ in the SC-MIMO structure, the network entity 105-a may transmit part 0 of CB₀ of CW₀ via the spatial layer 210-a and via the time-frequency resource 215-a. and transmit part 0 of CB₀ of CW₀ via the spatial layer 210-b and time-frequency resource 215-b, which may form the diagonal mapping across the spatial layers 210 and the time and frequency resources 215.

In such examples, the rate of SC-MIMO (e.g., the single CW rate) may be based on the collective channel quality across the spatial layers 210. By using a diagonal structure (e.g., similar to D-BLAST), a CW may be able to capture more channel realizations. That is, the CW may be transmitted over more channels, thereby improving communications between the network entity 105-a and the UE 115-a. To perform de-mapping for CBs transmitted with SC-MIMO, a SIC process may be implemented. A first CB may be demodulated and decoded first. When the first CB is successfully decoded, the CB may be subtracted from the received signal and the next CB may be demodulated and decoded. After successful decoding, the second CB may be subtracted from the received signal. This procedure may be repeated until all CBs may be successfully decoded or until CB decoding failure is declared.

For example, the network entity 105-a (or the transmitting wireless device in general) may divide CW₀ into N CBs and transmit it as PDSCH 205. To decode CW₀, the UE 115-a (or the receiving wireless device in general) may first decode CB₀ by decoding part 0 of CB₀ in spatial layer 210-a and time-frequency resource 215-a, then part 1 of CB₀ in spatial layer 210-b and time-frequency resource 215-b. After decoding CB₀, the UE 115-a may subtract CB₀ from the signal received in PDSCH 205 and may decode CB₁ by first decoding part 0 of CB₁ in spatial layer 210-a and time-frequency resource 215-b, then decoding part 1 of CB₁ in spatial layer 210-b and time-frequency resource 215-c. The UE 115-a may continue decoding CB parts and CBs received via the spatial layers 210 and the time and frequency resources 215 (e.g., the time and frequency resources 215-a, 215-b, 215-c, 215-d, 215-c, and 215-f) in such a manner until CB_{N} is decoded, which may be a CB of a different size or may be divided into multiple parts to terminate the diagonal structure of CW₀. After the UE 115-a has decoded all CB parts and resulting CBs, the UE 115-a may have decoded CW₀. If the UE 115-a experiences CB decoding failure at any point in the decoding process, the UE 115-a may stop decoding and may indicate the failure to the network entity 105-a. In some cases, the UE 115-a may request a retransmission of the PDSCH 205 or part of PDSCH 205 in the case of CB decoding failure.

In some examples, for PDSCH 205, the UE 115-a may implement a procedure for determining a TBS associated with CW₀ (e.g., determine a size of the CW), such that the UE 115-a may successfully identify and receive each CB part of the CW₀. For example, the UE 115-a may receive a resource allocation for the PDSCH from the network entity 105-a, where, the resource allocation may be sent via control signaling, such as via downlink control information (DCI). In some examples, a modulation and coding scheme (MCS) field in the DCI may not be reserved and the UE 115-a may implement a procedure to determine the TBS based on the MCS field being non-reserved. In accordance with the resource allocation, the UE 115-a may determine a quantity of resource elements (REs) (e.g., N′_{RE}) allocated within a slot. To do so, the UE may determine the quantity of REs allocated for a PDSCH within a physical resource block (PRB) using Equation 1.

$${N}_{RE}^{′} = {N}_{sc}^{R B} * {N}_{s y m b}^{s h} - {N}_{DMRS}^{PRB} - {N}_{o h}^{PRB} \qquad ( 1 )$$

$${N}_{s c}^{R B}$$

may be the quantity of subcarriers in a PRB. In some cases,

$${N}_{s c}^{R B} = 12 .$$

$${N}_{s y m b}^{s h}$$

may be the quantity of orthogonal frequency division multiplexing (OFDM) symbols in a slot.

$${N}_{DMRS}^{PRB}$$

may be the quantity of KEs allocated for demodulation reference signals (DMRS) for a PRB in the scheduled duration, including overhead of DMRS code division multiplexing (CDM) groups indicated by DCI format 1_0/1_1.

$${N}_{o h}^{PRB}$$

may be the overhead configured by a higher layer parameter (e.g., Xoh-PDSCH). If the higher layer parameter is not configured (e.g., configured with a value from 0, 6, 12, or 18), the higher layer parameter is set to zero.

Based on calculating the quantity of REs allocated for the PDSCH (N′_{RE}), the UE 115-a may determine a quantized quantity of RES (N′_{RE}) allocated for the PDSCH within a PRB using a table relating the calculated quantity of RES (N′_{RE}) to the quantized quantity of RES (N′_{RE}), such as Table 1.

TABLE 1
Example of an RE Quantization Table

| N′_{RE} | N̅′_{RE} |
|---|---|
| ≤9 | 6 |
| 9 < N′_{RE} ≤ 15 | 12 |
| 15 < N′_{RE} ≤ 30 | 18 |
| 30 < N′_{RE} ≤ 57 | 42 |
| 57 < N′_{RE} ≤ 90 | 72 |
| 90 < N′_{RE} ≤ 126 | 108 |
| 126 < N′_{RE} ≤ 150 | 144 |
| 150 < N′_{RE} | 156 |

The UE 115-a may determine a total quantity of REs (N_{RE}) allocated for the PDSCH over all the allocated PRBs based on the quantized quantity of REs using Equation 2 (where n_{PRB} may be the total quantity of allocated PRBs for the PDSCH).

$${N}_{R E} = {\overline{N}}_{RE}^{′} \cdot {n}_{PRB} \qquad ( 2 )$$

In response to obtaining the total quantity of REs (N_{RE}), the UE 115-a may determine an intermediate quantity of information bits (N_{info}) based on the total quantity of RES (N_{RE}) using Equation 3.

$${N}_{info} = {N}_{R E} \cdot R \cdot {Q}_{m} \cdot υ \qquad ( 3 )$$

R and Qₘ may be determined from the MCS field, which may be a non-reserved value, where R may be a code rate, Qₘ may be the modulation scheme, and v may correspond to a quantity of physical control shared channel (PCSCH) layers.

In some cases, the quantity of information bits (N_{info}) may be less than or equal to a threshold (e.g., 3824). In such cases, the UE 115-a may quantize the quantity of information bits (N_{info}) to determine a quantized quantity of information bits, N′_{info}, using Equation 4.

$${N}_{info}^{′} = max ( 24 , {2}^{n} \cdot ⌊ \frac{{N}_{info}}{{2}^{n}} ⌋ ) , n = max ( 3 , ⌊ {log}_{2} ( {N}_{info} ) ⌋ - 6 ) \qquad ( 4 )$$

After determining the quantized quantity of information bits (N′_{info}), the UE 115-a may determine the closest TBS that is greater than or equal to the quantized quantity of information bits (N′_{info}) using a table, such as Table 2.

TABLE 2
Example of a TBS Quantization Table

| INDEX | TBS |
|---|---|
| 1 | 24 |
| 2 | 32 |
| 3 | 40 |
| 4 | 48 |
| 5 | 56 |
| 6 | 64 |
| 7 | 72 |
| 8 | 80 |
| 9 | 88 |
| 10 | 96 |
| 11 | 104 |
| 12 | 112 |
| 13 | 120 |
| 14 | 128 |
| 15 | 136 |
| 16 | 144 |
| 17 | 152 |
| 18 | 160 |
| 19 | 168 |
| 20 | 176 |
| 21 | 184 |
| 22 | 192 |
| 23 | 208 |
| 24 | 224 |
| 25 | 240 |
| 26 | 256 |
| 27 | 272 |
| 28 | 288 |
| 29 | 304 |
| 30 | 320 |
| 31 | 336 |
| 32 | 352 |
| 33 | 368 |
| 34 | 384 |
| 35 | 108 |
| 36 | 432 |
| 37 | 456 |
| 38 | 480 |
| 39 | 504 |
| 40 | 528 |
| 41 | 552 |
| 42 | 576 |
| 43 | 608 |
| 44 | 640 |
| 45 | 672 |
| 46 | 704 |
| 47 | 736 |
| 48 | 768 |
| 49 | 808 |
| 50 | 848 |
| 51 | 888 |
| 52 | 928 |
| 53 | 984 |
| 54 | 1032 |
| 55 | 1064 |
| 56 | 1128 |
| 57 | 1160 |
| 58 | 1192 |
| 59 | 1224 |
| 60 | 1256 |
| 61 | 1288 |
| 62 | 1320 |
| 63 | 1352 |
| 64 | 1416 |
| 65 | 1480 |
| 66 | 1544 |
| 67 | 1608 |
| 68 | 1672 |
| 69 | 1736 |
| 70 | 1800 |
| 71 | 1864 |
| 72 | 1928 |
| 73 | 2024 |
| 74 | 2088 |
| 75 | 2152 |
| 76 | 2216 |
| 77 | 2280 |
| 78 | 2408 |
| 79 | 2472 |
| 80 | 2536 |
| 81 | 2600 |
| 82 | 2664 |
| 83 | 2728 |
| 84 | 2792 |
| 85 | 2856 |
| 86 | 2976 |
| 87 | 3104 |
| 88 | 3240 |
| 89 | 3368 |
| 90 | 3496 |
| 91 | 3624 |
| 92 | 3752 |
| 93 | 3824 |

For example, if N′_{info}=3000, the TBS may be 3104, using Table 2.

In some cases, the quantity of information bits may be greater than a threshold (e.g., 3824). In these cases, the quantity of information bits may be quantized to determine N′_{info} using Equation 5.

$${N}_{info}^{′} = {2}^{n} \cdot round ( \frac{{N}_{info} - 24}{{2}^{n}} ) , n = ⌊ {log}_{2} ( {N}_{info} - 24 ) ⌋ - 5 \qquad ( 5 )$$

In Equation 5, ties in the round function may be broken towards the next largest integer.

After determining the quantized quantity of information bits (N′_{info}) with Equation 5, the UE 115-a may determine the TBS based on Equation 6, Equation 7, or Equation 8. If the code rate (R), determined by the MCS field of the DCI, is less than or equal to a first threshold (e.g., 0.25 or ¼), the UE 115-a may utilize Equation 6 to determine the TBS.

$$T B S = 8 \cdot C \cdot ⌈ \frac{{N}_{info}^{′} + 24}{8 \cdot C} ⌉ - 24 , C = ⌈ \frac{{N}_{info}^{′} + 24}{3816} ⌉ \qquad ( 6 )$$

If the code rate (R) is greater than the first threshold and the quantized quantity of information bits (N′_{info}) is greater than a second threshold (e.g., 8424), the UE 115-a may implement Equation 7 to determine the TBS.

$$T B S = 8 \cdot C \cdot ⌈ \frac{{N}_{info}^{′} + 24}{8 \cdot C} ⌉ - 24 , C = ⌈ \frac{{N}_{info}^{′} + 24}{8424} ⌉ \qquad ( 7 )$$

If the code rate (R) is greater than the first threshold and the quantized quantity of information bits (N′_{info}) is less than or equal to the second threshold (e.g., 8424), the UE 115-a may implement Equation 8 to determine the TBS.

$$T B S = 8 \cdot ⌈ \frac{{N}_{info}^{′} + 24}{8 \cdot C} ⌉ - 24 , C = ⌈ \frac{{N}_{info}^{′} + 24}{8424} ⌉ \qquad ( 8 )$$

In some cases, the MCS entries of the DCI associated with the PDSCH transmission may correspond to reserved values. In such cases, to determine a TBS, the UE 115-a may assume the TBS to be determined based on the DCI transported via the most recent physical downlink control channel (PDCCH) for the same CW that may have a non-reserved MCS. If there is no such PDCCH for the same CW (e.g., a PDCCH that may contain a non-reserved MCS value) and if the initial PDSCH for the CW is semi-persistently scheduled, the UE 115-a may determine the TBS from the most recent PDCCH that assigns the semi-persistent scheduling.

Based on the determined TBS and the code rate (R), the UE 115-a may determine to segment the CWs (e.g., transport blocks) into a quantity of CBs (n_{cbs}). If the TBS is less than or equal to a threshold (e.g., 3824), the UE 115-a may determine that the quantity of CBs is one. That is, the UE 115-a may not segment the CW based on the TBS of the CW being less than the threshold (e.g., the CW may be small enough to be transmitted without segmentation). If the TBS of the CW is greater than the threshold (e.g., 3824) and the code rate is less than or equal to a second threshold (e.g., 0.25), the quantity of CBs may be determined with Equation 9.

$${n}_{c b s} = ⌈ \frac{T B S + 24}{3816} ⌉ \qquad ( 9 )$$

Otherwise, if the code rate is greater than the second threshold, the quantity of CBs may be determined with equation 10.

$${n}_{c b} = ⌈ \frac{T B S + 24}{8424} ⌉ \qquad ( 10 )$$

After determining the quantity of CBs (n_{cbs}), the UE 115-a may adjust the quantity of CBs to be compatible with SC-MIMO. For example, depending on the quantity of resources allocated, the CBs may have different lengths after encoding (e.g., two lengths may be generated). For example, in some cases, TBS+24 may not be divisible by 3816, 8424, or both. This may yield CBs of different lengths. CBs of different lengths may not align with a diagonal structure of SC-MIMO. For example, the UE 115-a may divide CB₀ into two parts and may map part 1 to time-frequency resource 215-b and spatial layer 210-b. The UE 115-a may divide CB₁ into two parts and may map part 0 to time-frequency resource 215-b and spatial layer 210-a. If CB₀ and CB₁ are of different lengths, part 1 of CB₀ and part 0 of CB₁ may overlap in the same time-frequency resource 215-b, but may be different lengths and thus may not align in time-frequency resource 215-b, which may result in poor or no communications during SC-MIMO.

In accordance with the techniques described herein, the UE 115-a may adjust the quantity of CBs or the quantity of CBs of specific sizes. That is, because SC-MIMO may implement a diagonal structure, the quantity of CBs or quantity of CBs of specific sizes may be adjusted to ensure compatibility with SC-MIMO design structures.

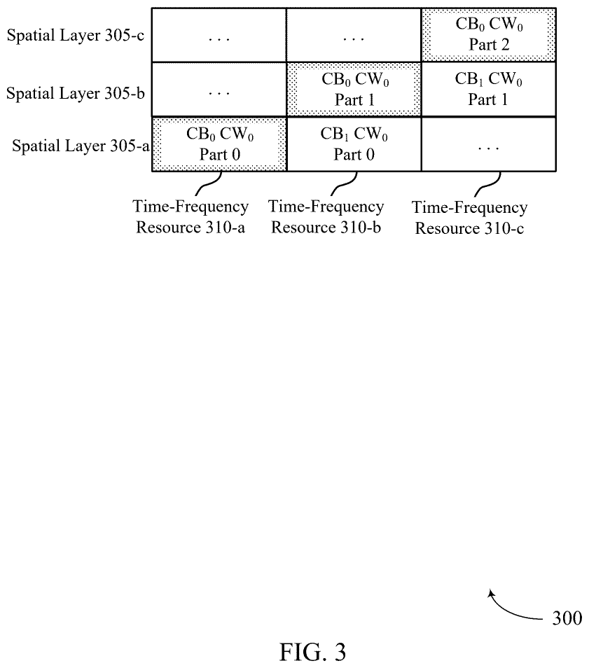

For example, in some implementations, based on receiving a resource allocation for a PDSCH and determining the quantity of CBs (n_{cbs}), the UE 115-a may decrease the quantity of CBs to a second quantity of CBs such that the quantity of time-frequency resources 215 allocated for the PDSCH may evenly divide a combination of the second quantity of CBs and a quantity of spatial resources (e.g., layer blocks, spatial layers 210) associated with the communication of the PDSCH. This may indicate that the CBs are the same size. For example, CB₀ may be the same size as CB₁, such that parts of CB₀ and CB₁ may both be mapped to time-frequency resource 215-b. In some cases, decreasing the quantity of CBs may result in a second quantity of CBs that may be too small. That is, the CW may not be divided into enough CBs and the resulting CBs may be larger than supported for the transmission scheme. In these cases, the UE 115-a may increase the quantity of CBs to a second quantity of CBs such that the quantity of time-frequency resources allocated for the PDSCH may evenly divide a combination of the second quantity of CBs and a quantity of spatial resources associated with the communication of the PDSCH. Such techniques may be further described herein with reference to FIG. 3.

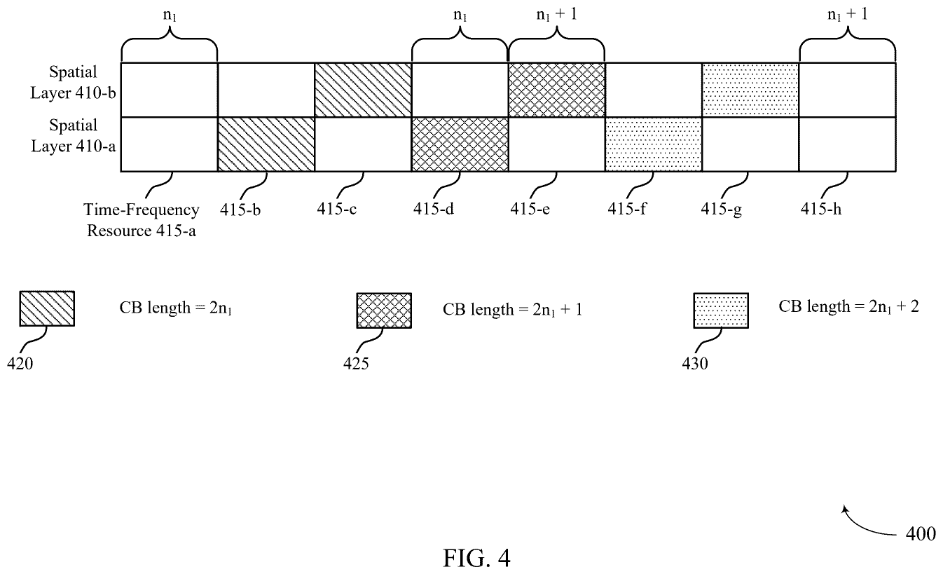

In some implementations, based on receiving the resource allocation for the PDSCH and determining the quantity of CBs based on the TBS, the UE 115-a may maintain the quantity of CBs as a total quantity of CBs, but may divide the quantity of CBs into a second quantity of CBs of a first size and a third quantity of CBs of a second size. The first size and the second size may be similar enough that the diagonal structure of SC-MIMO may support the slight difference in size, or the CB parts of each CB may be stacked to align the different sizes of CB parts. For example, CB₀ may be a similar size as CB₁, such that the UE 115-a may map parts of CB₀ and CB₁ to time-frequency resource 215-b, despite the slightly different sizes of CB₀ and CB₁. Additionally, or alternatively, CB₀ and CB₁ may be different sizes, but the UE 115-a may not divide each CB into equal parts. In some cases, the UE 115-a may divide CB₀ and CB₁ into parts such that part 1 of CB₀ and part 0 of CB₁ may be the same size, and may share time-frequency resource 215-b. In some cases, the UE 115-a may also include a fourth quantity of CBs of a third size, the third size between the first size and the second size. In this way, the multiple CBs may be communicated in accordance with the diagonal SC-MIMO structure. Such techniques may be further described herein with reference to FIG. 4.

Although aspects of the wireless communications system 200 are discussed as implemented by the UE 115-a, the aspects discussed herein with respect to the wireless communications system 200 may be implemented by the network entity 105-a. In particular, in some cases, to support communication between a transmitting wireless device (e.g., UE, network entity) and a receiving wireless device (e.g., UE, network entity), both the transmitting wireless device and the receiving wireless device may implement aspects of the wireless communications system 200. For example, the network entity 105-a may implement aspects of wireless communications system 200 in order to transmit the PDSCH 205, and the UE 115-a may implement aspects of wireless communications system 200 in order to receive and decode PDSCH 205.

FIG. 3 shows an example of a CB diagram 300 that supports transport block segmentation in accordance with one or more aspects of the present disclosure. For example, the CB diagram 300 may be implemented by a UE and a network entity, which may be examples of the corresponding devices as described herein, including with reference to FIGS. 1 and 2. The techniques described in the context of the CB diagram 300 may enable the UE 115 and/or the network entity 105 to adjust a quantity of CBs that a CW (e.g., transport block) may be segmented into in order to support SC-MIMO.

In some implementations, the UE 115, the network entity 105, or both, as described with reference to FIGS. 1 and 2, may perform TBS determination and segmentation to ensure compatibility with an SC-MIMO mapping. For example, the UE 115 may compute a TBS (e.g., virtual TBS) using the procedure, as described in FIG. 2, and then may modify the segmentation to be compatible with SC-MIMO. In some examples, the UE may adjust the quantity of CBs a transport block may be segmented into to ensure compatibility with SC-MIMO. That is, the UE may ensure all CBs within the CB diagram have a similar size (e.g., identical size).

In some implementations, as described herein with reference to FIG. 2, a quantity of CBs may be determined using a resource allocation that may include a non-reserved MCS value. That is, the TBS determination and segmentation may be MCS-dependent, and the UE may implement the procedure described with reference to FIG. 2 for non-reserved MCS values to determine a quantity of CBs (n_{cbs}). In some implementations, as described with reference to FIG. 2, the TBS and segmentation may be MCS-independent. That is, the code rate, R, may be a fixed value (e.g., predefined and/or signaled to the UE from a network entity). In these implementations, the UE may implement the segmentation procedure, described with reference to FIG. 2, to determine a TBS, where TBS=Nᵣₑₛ·R, in order to obtain the quantity of CBs. In some cases, the value of R may be 1, but may not be 0. The value of R may range from 0 to 1. Nᵣₑₛ may be computed based on a quantity of OFDM symbols in an SC-MIMO instance, which the UE or network entity may limit or implement.

After determining the quantity of CBs, the UE may reduce the quantity of CBs until a length constraint from a layer decomposition of the CB diagram is satisfied. For example, the UE may reduce the quantity of CBs (n_{cbs}) until a quantity of time-frequency resources 310 (Nᵣₑₛ) may divide n_{cbs}+n_{blocks}−1, where n_{blocks} may be a quantity of layer blocks or spatial layers 305 (e.g., n_{blocks}=3 for spatial layers 305-a, 305-b, and 305-c). In some cases, reducing the quantity of CBs until the constraint is satisfied may result in CBs of sizes that are greater than can be supported. In these cases, the UE may return to the original quantity of CBs (n_{cbs}) and increase the quantity of CBs until the constraint is satisfied. Longer CBs may be more likely to be successfully decoded, and thus the UE may prioritize fewer CBs of greater size. However, there may be a threshold size of CBs that the SC-MIMO data transmission may support. The UE may not be able to decrease the quantity of CBs while satisfying this threshold, and instead may increase the quantity of CBs in order to ensure the CBs may be identical sizes. This may result in more CBs of smaller size.

As an illustrative example, there may some quantity of time-frequency resources 310 (e.g., Nᵣₑₛ) available for transmission at the UE. The UE may also have a layer decomposition constraint. For example, the quantity of spatial layers 305 may be some value, such as 3. Accordingly, the UE may reduce the quantity of CBs (n_{cbs}) until the total quantity of time-frequency resources 310 evenly divides the sum of the quantity of CBs and one less than the quantity of spatial layers 305 (e.g., layer blocks). For example, the total quantity of time-frequency resources 310 may divide n_{cbs}+2 if n_{blocks}=3, as in CB diagram 300. If the total quantity of time-frequency resources 310 divides n_{cbs}+n_{blocks}−1, the quantity of CBs may not be adjusted, or the CBs may already be of equal size. If the total quantity of time-frequency resources 310 does not divide n_{cbs}+n_{blocks}−1, the UE may decrease or increase the quantity of CBs by 1 and re-evaluate if the total quantity of time-frequency resources 310 may divide the sum of the new quantity of CBs and one less than the quantity of layer blocks (e.g., n_{cbs}+n_{blocks}−1, where n_{cbs} is the new or adjusted quantity of CBs).

After adjusting the quantity of CBs, the UE may segment the CBs into parts, which may be associated with a quantity of spatial layers 305. For example, CB₀ and CB₁ may be divided into three parts (e.g., Part 0, Part 1, Part 2) and each part may be transmitted (or received) via a different spatial layer 305. For example, part 0 of CB₀ and part 0 of CB₁ may be transmitted via spatial layer 305-a, and part 1 of CB₀ and part 1 of CB₁ may be transmitted via spatial layer 305-b. The CB parts may also be transmitted via different time-frequency resources 310 (e.g., the time frequency resources 310-a, 310-b, and 310-c) to support the diagonal structure of SC-MIMO. For example, part 0 of CB₀ may be transmitted in time-frequency resource 310-a, while part 1 of CB₀ and part 0 of CB₁ may be transmitted in time-frequency resource 310-b. Thus, the UE may segment a CW into CBs and the CBs into CB parts, before mapping the CB parts to appropriate spatial layers 305 and time-frequency resource 310.

By ensuring that the CBs may be equal sizes, the UE may be able to support dividing the CBs into CB parts and diagonally mapping the CBs in CB diagram 300. For example, because the CBs may be of equal sizes, Part 1 of CB 0 in time-frequency resource 310-b and spatial layer 305-b may be the same length as Part 0 of CB 1 in time-frequency resource 310-b and spatial layer 305-a. That is, the CB parts of different CBs may be identical sizes, allowing them to overlap in time-frequency resources 310 to form the diagonal structure of SC-MIMO.

In some cases, the CBs may align with (e.g., terminate at) OFDM symbol boundaries. That is, each OFDM symbol may contain an integer quantity of CBs. For example, all CBs of the CB diagram 300 may be mapped to and transmitted within one OFDM symbol. Additionally, or alternatively, each CB may be transmitted within one OFDM symbol. That is, CB₀ may be transmitted within one OFDM symbol. Additionally, or alternatively, CBs may span multiple OFDM symbols (e.g., two OFDM symbols). However, a CB-to-symbol split may be aligned with spatial layer 305 decomposition (e.g., layer block decomposition). That is, the OFDM symbol boundaries may align with the boundaries in the diagonal SC-MIMO structure such that each OFDM symbol may contain an integer quantity of CB parts. For example, the UE may map part 0 of CB₀ to a first OFDM symbol, while the UE may map part 1 of CB₀ and part 0 of CB₁ to a second OFDM symbol. Further, the UE may map part 2 of CB₀ and part 1 of CB₁ to a third OFDM symbol. In some cases, such as discussed with reference to FIG. 2, the UE may split each CB into two CB parts and may map each CB to one OFDM symbol, or may map each CB part to one OFDM symbol (e.g., the first half of CB₀ may be mapped to a first OFDM symbol, the second half of CB₀ may be mapped to a second OFDM symbol).

Although aspects of the CB diagram 300 are discussed as implemented by, or implementing, a UE, the aspects discussed herein with respect to the CB diagram 300 may be implemented by other wireless devices, such as a network entity. In particular, in some cases, to support communication between a transmitting wireless device (e.g., UE, network entity) and a receiving wireless device (e.g., UE, network entity), both the transmitting wireless device and the receiving wireless device may implement aspects of the CB diagram 300.

FIG. 4 shows an example of a CB diagram 400 that supports transport block segmentation in accordance with one or more aspects of the present disclosure. For example, the CB diagram 400 may be implemented by a UE and a network entity, which may be examples of the corresponding devices as described herein, including with reference to FIGS. 1 and 2. The techniques described in the context of the CB diagram 400 may enable the UE to adjust quantities of CBs of different sizes during transport block segmentation in order to support SC-MIMO.

In some implementations, a UE, such as UEs 115 described with reference to FIGS. 1 and 2, may perform TBS determination and segmentation to ensure compatibility with an SC-MIMO mapping. The UE may compute a TBS (e.g., virtual TBS) using the procedure, as described herein with reference to FIG. 2, and perform transport block segmentation on the CW in a manner that is compatible with SC-MIMO. In some examples, the UE may adjust a quantity of CBs of a first size and a quantity of CBs of a second size to ensure transport block segmentation compatibility with SC-MIMO.

In some implementations, the UE may determine a quantity of CBs (n_{cbs}) based on the procedure described herein with reference to FIG. 2. Some CB diagrams 400 may support CBs of different lengths within an SC-MIMO design. For example, within the SC-MIMO structure, there may be CBs 420 of length 2n₁, CBs 425 of length 2n₁+1, and CBs 430 with length 2n₁+2. n₁ may be determined based on the quantity of time-frequency resources 415 allocated for the PDSCH at the UE. n₁ may be determined to ensure the quantity of time-frequency resources 415 may be divided as equally as possible between different layer blocks or spatial layers 410. The CBs 420, 425, and 430 may be of similar lengths to maintain compatibility with the SC-MIMO structure. In some examples, the lengths of the CBs 420, 425, and 430 may be similar enough that the differences may be negligible within the SC-MIMO structure. In some examples, the CBs 420, 425, and 430 may be overlaid in order to interlace the CB parts of different lengths.

To support CBs 420, 425, and 430 of different lengths, the UE may determine a quantity of CBs 420, a quantity of CBs 425, and a quantity of CBs 430 that satisfy the total quantity of CBs and the constraints of SC-MIMO design. That is, the UE may maintain the same total quantity of CBs for a transport block, but may adjust the quantity CBs of different sizes. The quantity of CBs 425 may be restricted to specific values, such as zero or two. That is, there may be zero or two CBs 425 with length 2n₁+1 in a CB diagram 400.

For example, the UE may determine that the quantity of CBs (n_{cbs}) is two. Accordingly, the UE may receive the resource allocation for the PDSCH that may indicate the quantity of time-frequency resources 415 (Nᵣₑₛ), which the UE may use to determine the value of a variable, n₁. For example, the UE may determine that the quantity of time-frequency resources 415 may be 2n₁ (e.g., an even quantity of time-frequency resources) or 2n₁+1 (e.g., an odd quantity of time-frequency resources), which the UE may use to determine the value of n₁. If the quantity of time-frequency resources 415 is 2n₁+1, the UE may determine that the quantity of CBs 430 may be zero, the quantity of CBs 425 may be two, and the quantity of CBs 420 may be zero. If the quantity of time-frequency resources 415 is 3n₁, the UE may determine that the quantity of CBs 430 may be zero, the quantity of CBs 425 may be zero, and the quantity of CBs 420 may be two. In either case, the UE may ensure that the total quantity of CBs may be two, but the UE may allow the lengths of the CBs to be different depending on the quantity of time-frequency resources 415.

In another example, the UE may determine that the quantity of CBs (n_{cbs}) is three. Accordingly, the UE may receive the resource allocation for the PDSCH that may indicate the quantity of time-frequency resources 415 (Nᵣₑₛ), which the UE may use to determine the value of a variable, n₁. For example, the UE determine whether the quantity of time-frequency resources 415 may be 3n₁+1, 3n₁+2, or 3n₁. If the quantity of time-frequency resources 415 is 3n₁+1, the UE may determine that the quantity of CBs 430 may be zero, the quantity of CBs 425 may be two, and the quantity of CBs 420 may be one. If the quantity of time-frequency resources 415 is 3n₁+2, the UE may determine that the quantity of CBs 430 may be one, the quantity of CBs 425 may be two, and the quantity of CBs 420 may be zero. If the quantity of time-frequency resources 415 is 3n₁, the UE may determine that the quantity of CBs 430 may be zero, the quantity of CBs 425 may be zero, and the quantity of CBs 420 may be three. In each case, the UE may ensure that the total quantity of CBs may be three, but the UE may allow the lengths of the CBs may be different depending on the quantity of time-frequency resources 415.

If the total quantity of CBs exceeds three, the UE may determine how many CBs 420 and CBs 430 may be included in the CB diagram using Equations 11 and 12. The UE may assume there are two CBs 425, as reflected in Equation 11.

$$x + y + 2 = {n}_{c b s} \qquad ( 11 )$$

$$( x + 1 ) ( {n}_{1} + 1 ) + ( y + 1 ) \cdot {n}_{1} = {N}_{r e s} \qquad ( 12 )$$

x may be the quantity of CBs 430 and y may be the quantity of CBs 420. n₁ may be determined according to the quantity of time-frequency resources 415 allocated for the SC-MIMO transmission and may be a variable that connects the different CBs 420, 425, and 430, ensuring they are of similar sizes. In some cases, it may be beneficial to have a greater quantity of longer CBs, such as CBs 430, because longer CBs may be more likely to be successfully decoded. In these cases, the UE may determine the quantity of CBs 420 and 430 by assuming that the quantity of CBs 420, y, may be 1 and increasing the value of y until there may be an integer solution for x and n₁ in Equations 11 and 12. In some cases, the UE may determine the quantity of CBs 420 and 430 by assuming that the quantity of CBs 430, x, may be 1 and increasing the value of x until there may be an integer solution for y and n₁ in Equations 11 and 12

Within an SC-MIMO CB diagram 400, a CB used to start the SC-MIMO decoding process may be a “special” CB₀ which may have a different length. That is, the UE may ensure that CBs of specific lengths, such as a CB 420, 425, or 430 may be used as the special CB. This may allow the UE to support CBs of differing lengths.

The CB diagram 400 may be an example of an SC-MIMO structure that implements CBs of different lengths. For example, the UE may split a CB 420 into CB parts of length n₁ and map the CB parts diagonally to the CB diagram 400. The UE may split a CB 425 into two CB parts, one of length n₁ and one of length n₁+1, and may map the CB parts diagonally to the CB diagram 400. The UE may split a CB 430 into CB parts of length n₁+1 and may map the CB parts diagonally. In this way, time-frequency resources 415-a, 415-b, 415-c, and 415-d may be of length n₁ and time-frequency resources 415-c, 415-f, 415-g, and 415-h may be of length n₁+1.

In some cases, it may be beneficial for the UE to place a longer CB or CB part at the beginning of the transmission. This may allow the UE to decode longer CBs prior to shorter ones. Because longer CBs may have a higher probability of being decoded properly, this may increase the chance of proper decoding of the CBs in CB diagram 400. In this case, the UE may change the order of the CB diagram 400 such that the CB parts of CB 430 occur first, such as in time-frequency resources 415-b and 415-c.

In some implementations, the CBs may align with (e.g., terminate at) OFDM symbol boundaries. That is, each OFDM symbol may contain an integer quantity of CBs. For example, the entire CB diagram 300 may be transmitted within one OFDM symbol. In some implementations, CBs may span multiple OFDM symbols (e.g., two OFDM symbols). However, a CB-to-symbol split may be aligned with layer block decomposition. That is, the OFDM symbol boundaries may align with the boundaries in the diagonal SC-MIMO structure such that each OFDM symbol may contain an integer quantity of CB parts.

In some cases, the CBs may align with (e.g., terminate at) OFDM symbol boundaries. That is, each OFDM symbol may contain an integer quantity of CBs. For example, all CBs of the CB diagram 400 may be mapped to and transmitted within one OFDM symbol. Additionally, or alternatively, each CB may be transmitted within one OFDM symbol. That is, CB 420 may be transmitted within one OFDM symbol.

Additionally, or alternatively, CBs may span multiple OFDM symbols (e.g., two OFDM symbols). However, a CB-to-symbol split may be aligned with spatial layer 410 decomposition (e.g., layer block decomposition). That is, the OFDM symbol boundaries may align with the boundaries in the diagonal SC-MIMO structure such that each OFDM symbol may contain an integer quantity of CB parts. For example, the UE may map a first part of CB 420 (e.g., the part mapped to spatial layer 410-a and time-frequency resource 415-b) to a first OFDM symbol, while the UE may map a second part of CB 420 (e.g., the part mapped to spatial layer 410-b and time-frequency resource 415-c) to a second OFDM symbol. In some cases, such as discussed with reference to FIG. 2, the UE may split each CB into two CB parts and may map each CB to one OFDM symbol, or may map each CB part to one OFDM symbol (e.g., the first half of CB 420 may be mapped to a first OFDM symbol, the second half of CB 420 may be mapped to a second OFDM symbol).

Although aspects of the CB diagram 400 are discussed as implemented by, or implementing, a UE, the aspects discussed herein with respect to the CB diagram 400 may be implemented by other wireless devices, such as a network entity. In particular, in some cases, to support communication between a transmitting wireless device (e.g., UE, network entity) and a receiving wireless device (e.g., UE, network entity), both the transmitting wireless device and the receiving wireless device may implement aspects of the CB diagram 400.

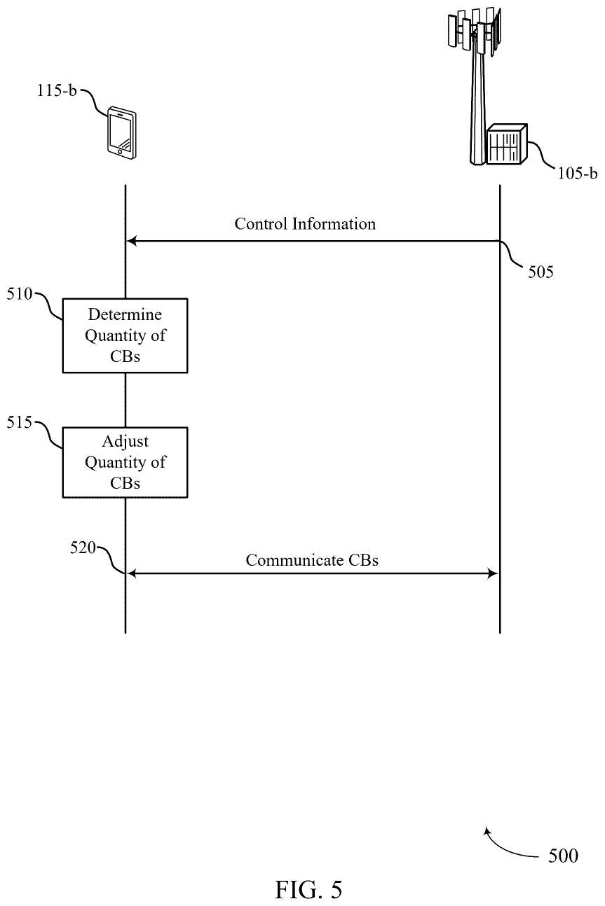

FIG. 5 shows an example of a process flow 500 that supports transport block segmentation in accordance with one or more aspects of the present disclosure. For example, the wireless communications system process flow may include a UE 115-a and a network entity 105-a, which may be examples of the corresponding devices as described herein, including with reference to FIGS. 1-4. The techniques described in the context of the process flow 500 may enable the UE 115-a to adjust transport block segmentation in order to support SC-MIMO.

At 505, the UE 115-a may receive, from the network entity 105-a, control information including a resource allocation for communication of a PDSCH. For example, the UE 115-a may receive a DCI including a resource allocation.

At 510, the UE 115-a may determine a first quantity of CBs associated with a TBS of the PDSCH, where the TBS may be based on the resource allocation, as described at 505. In some implementations, the UE 115-a may determine a quantity of information bits associated with the PDSCH based on a quantity of resource elements associated with the PDSCH, a coding rate associated with the PDSCH, a modulation order associated with the PDSCH, the quantity of spatial layers, or a combination thereof. The UE 115-a may determine the TBS based on the quantity of information bits, the coding rate, or both, where determining the first quantity of CBs may be based on determining the TBS. In some cases, the coding rate may be indicated via the resource allocation, as described at 505. In some cases, the coding rate may be a fixed coding rate value, and determining the quantity of information bits and the TBS may be based on the fixed coding rate value.

In some implementations, at 515, the UE 115-a may adjust the first quantity of CBs to a second quantity of CBs based at least in part on a quantity of time and frequency resources allocated for the PDSCH, a quantity of spatial layers associated with the communication of the PDSCH, or both, as described herein with reference to FIG. 3. In some cases, adjusting the first quantity of CBs may include decreasing the first quantity of CBs to the second quantity of CBs such that the quantity of time and frequency resources allocated for the PDSCH evenly divides a combination of the second quantity of CBs and the quantity of spatial layers associated with the communication of the PDSCH. In some cases, adjusting the first quantity of CBs may include decreasing the first quantity of CBs to a third quantity of CBs, and increasing, based on the third quantity of CBs failing to satisfy a threshold, the first quantity of CBs to the second quantity of CBs such that the quantity of time and frequency resources allocated for the PDSCH evenly divides a combination of the second quantity of CBs and the quantity of spatial layers associated with the communication of the PDSCH.

In some implementations, at 515, the UE 115-a may adjust the first quantity of CBs to a second quantity of CBs of a first size, to a third quantity of CBs of a second size that is less than the first size, or both based on a quantity of time and frequency resources allocated for the PDSCH, on the first quantity of CBs, or both, as described herein with reference to FIG. 4. In some cases, the UE 115-a may adjust the first quantity of CBs to the second quantity of CBs, to the third quantity of CBs, and to a fourth quantity of CBs of a third size based on the first quantity of CBs, the quantity of time and frequency resources, or both, wherein the third size is less than the first size and greater than the second size.

In some implementations, at 520, the UE 115-a may communicate, with the network entity 105-a and via the quantity of time and frequency resources using the quantity of spatial layers, the second quantity of CBs in accordance with adjusting the first quantity of CBs to the second quantity of CBs, as described at 515. For example, at 520, the UE 115-a may receive a PDSCH including the CBs, as described at 515. In some cases, time resources of the quantity of time and frequency resources may span a single OFDM symbol, where each CB of the second quantity of CBs may be divided into two or more CB parts, and where communicating the second quantity of CBs includes communicating each CB part of the second quantity of CBs via the first single OFDM symbol. In some examples, each CB part of a respective CB of the second quantity of CBs is transmitted via a respective spatial layer of the quantity of spatial layers and at a respective time within the single OFDM symbol.

In some cases, time resources of the quantity of time and frequency resources span two or more OFDM symbols, where each CB of the second quantity of CBs may be divided into two or more CB parts, and where communicating the second quantity of CBs may include communicating at least a first CB part of a first CB of the second quantity of CBs via a first OFDM symbol of the two or more OFDM symbols and communicating at least a second CB part of the first CB via a second OFDM symbol of the two or more OFDM symbols. In some examples, the UE 115-a may communicate at least the first CB part of the first CB via a first spatial layer of the quantity of spatial layers and may communicate at least the second CB part of the first CB via a second spatial layer of the quantity of spatial layers.

In some implementations, at 520, the UE 115-a may communicate, to the network entity 105-a and via the quantity of time and frequency resources using multiple spatial layers, the second quantity of CBs, the third quantity of CBs, or both in accordance with determining the second quantity of CBs and determining the third quantity of CBs, as described at 515. In some cases, the UE 115-a may communicate the second quantity of CBs prior to the third quantity of CBs in time based on the first size of the second quantity of CBs being greater than the second size of the third quantity of CBs. In some cases, the UE 115-a may communicate, via the quantity of time and frequency resources using multiple spatial layers, the fourth quantity of CBs in accordance with the adjusting, as described at 515. In some cases, the second quantity of CBs may be greater than the third quantity of CBs. In some cases, the first size of the second quantity of CBs includes a first quantity of information bits, the second size of the third quantity of CBs includes a second quantity of information bits, and the first quantity of information bits may be greater than the second quantity of information bits.

In some implementations, the time resources of the quantity of time and frequency resources may span a single OFDM, where each CB of the second quantity of CBs and each CB of the third quantity of CBs may be divided into two or more CB parts, and where the communicating includes communicating each CB part of the second quantity of CBs, each CB part of the third quantity of CBs, or both via the single OFDM symbol. In some examples, each CB part of a respective CB of the second quantity of CBs is transmitted via a respective spatial layer of the quantity of spatial layers and at a respective time within the single OFDM symbol, each CB part of a respective CB of the third quantity of CBs is transmitted via a respective spatial layer of the quantity of spatial layers and at a respective time within the single OFDM symbol, or both.

In some implementations, the time resources of the quantity of time and frequency resources may span two or more OFDM symbols, where the UE 115-a may divide each CB of the second quantity of CBs and each CB of the third quantity of CBs into two or more CB parts. The UE 115-a may communicate each CB part of a first CB of the second quantity of CBs via the two or more OFDM symbols, where the UE 115-a may communicate one or more CB parts of the first CB are communicated within a respective OFDM symbol of the two or more OFDM symbols. The UE 115-a may communicate each CB part of a first CB of the third quantity of CBs via the two or more OFDM symbols, where the UE 115-a may communicate one or more CB parts of the first CB via a respective OFDM symbol of the two or more OFDM symbols. In some examples, the UE 115-a may communicate at least a first CB part of the first CB of the second quantity of CBs via a first spatial layer of the quantity of spatial layers and via a first OFDM symbol of the two or more OFDM symbols, and may communicate at least a second CB part of the first CB of the second quantity of CBs via a second spatial layer of the quantity of spatial layers and via a second OFDM symbol of the two or more OFDM symbols. In some examples, the UE 115-a may communicate at least a first CB part of the first CB of the third quantity of CBs via a first spatial layer of the quantity of spatial layers and via a first OFDM symbol of the two or more OFDM symbols, and may communicate at least a second CB part of the first CB of the third quantity of CBs via a second spatial layer of the quantity of spatial layers and via a second OFDM symbol of the two or more OFDM symbols.

Although aspects of the process flow 500 are discussed as implemented by, or implementing, a UE or a network entity, the aspects discussed herein with respect to the process flow 500 may be implemented by other wireless devices. In particular, in some cases, to support communication between a transmitting wireless device (e.g., UE, network entity) and a receiving wireless device (e.g., UE, network entity), both the transmitting wireless device and the receiving wireless device may implement aspects of the process flow 500.

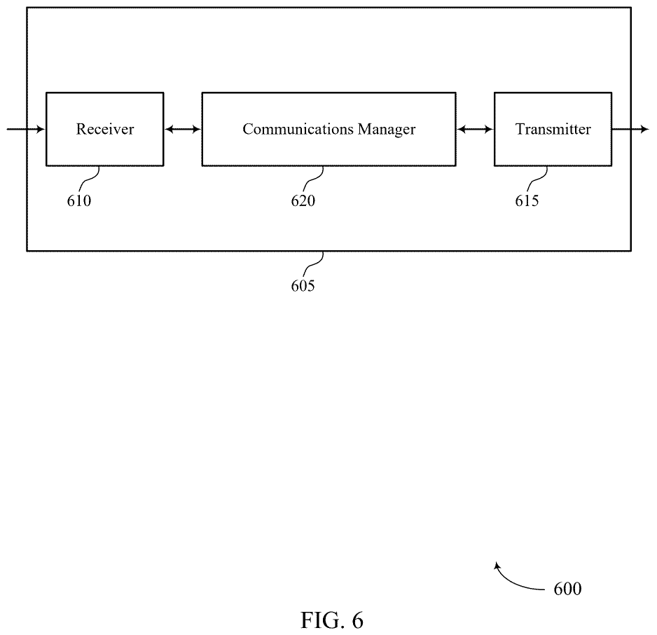

FIG. 6 shows a block diagram 600 of a device 605 that supports transport block segmentation in accordance with one or more aspects of the present disclosure. The device 605 may be an example of aspects of a UE 115 as described herein. The device 605 may include a receiver 610, a transmitter 615, and a communications manager 620. The device 605, or one or more components of the device 605 (e.g., the receiver 610, the transmitter 615, the communications manager 620), may include at least one processor, which may be coupled with at least one memory, to, individually or collectively, support or enable the described techniques. Each of these components may be in communication with one another (e.g., via one or more buses).

The receiver 610 may provide a means for receiving information such as packets, user data, control information, or any combination thereof associated with various information channels (e.g., control channels, data channels, information channels related to transport block segmentation). Information may be passed on to other components of the device 605. The receiver 610 may utilize a single antenna or a set of multiple antennas.

The transmitter 615 may provide a means for transmitting signals generated by other components of the device 605. For example, the transmitter 615 may transmit information such as packets, user data, control information, or any combination thereof associated with various information channels (e.g., control channels, data channels, information channels related to transport block segmentation). In some examples, the transmitter 615 may be co-located with a receiver 610 in a transceiver module. The transmitter 615 may utilize a single antenna or a set of multiple antennas.

The communications manager 620, the receiver 610, the transmitter 615, or various combinations or components thereof may be examples of means for performing various aspects of transport block segmentation as described herein. For example, the communications manager 620, the receiver 610, the transmitter 615, or various combinations or components thereof may be capable of performing one or more of the functions described herein.

In some examples, the communications manager 620, the receiver 610, the transmitter 615, or various combinations or components thereof may be implemented in hardware (e.g., in communications management circuitry). The hardware may include at least one of a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 620, the receiver 610, the transmitter 615, or various combinations or components thereof may be implemented in code (e.g., as communications management software) executed by at least one processor (e.g., referred to as a processor-executable code). If implemented in code executed by at least one processor, the functions of the communications manager 620, the receiver 610, the transmitter 615, or various combinations or components thereof may be performed by a general-purpose processor, a DSP, a CPU, a graphics processing unit (GPU), an ASIC, an FPGA, a microcontroller, or any combination of these or other programmable logic devices (e.g., configured as or otherwise supporting, individually or collectively, a means for performing the functions described in the present disclosure).

In some examples, the communications manager 620 may be configured to perform various operations (e.g., receiving, obtaining, monitoring, outputting, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to obtain information, output information, or perform various other operations as described herein.

The communications manager 620 may support wireless communications in accordance with examples as disclosed herein. For example, the communications manager 620 is capable of, configured to, or operable to support a means for receiving control information including a resource allocation for communication of a PDSCH. The communications manager 620 is capable of, configured to, or operable to support a means for determining a first quantity of CBs associated with a TBS of the PDSCH, where the TBS is based on the resource allocation. The communications manager 620 is capable of, configured to, or operable to support a means for adjusting the first quantity of CBs to a second quantity of CBs based on a quantity of time and frequency resources allocated for the PDSCH, a quantity of spatial layers associated with the communication of the PDSCH, or both. The communications manager 620 is capable of, configured to, or operable to support a means for communicating, via the quantity of time and frequency resources using the quantity of spatial layers, the second quantity of CBs in accordance with adjusting the first quantity of CBs to the second quantity of CBs.

Additionally, or alternatively, the communications manager 620 may support wireless communications in accordance with examples as disclosed herein. For example, the communications manager 620 is capable of, configured to, or operable to support a means for receiving control information including a resource allocation for communication of a PDSCH. The communications manager 620 is capable of, configured to, or operable to support a means for determining a first quantity of CBs associated with a TBS of the PDSCH, where the TBS is based on the resource allocation. The communications manager 620 is capable of, configured to, or operable to support a means for adjusting the first quantity of CBs to a second quantity of CBs of a first size, to a third quantity of CBs of a second size that is less than the first size, or both based on a quantity of time and frequency resources allocated for the PDSCH, on the first quantity of CBs, or both. The communications manager 620 is capable of, configured to, or operable to support a means for communicating, via the quantity of time and frequency resources using a set of multiple spatial layers, the second quantity of CBs, the third quantity of CBs, or both in accordance with determining the second quantity of CBs and determining the third quantity of CBs.

By including or configuring the communications manager 620 in accordance with examples as described herein, the device 605 (e.g., at least one processor controlling or otherwise coupled with the receiver 610, the transmitter 615, the communications manager 620, or a combination thereof) may support techniques for more efficient utilization of communication resources and improved communication reliability.

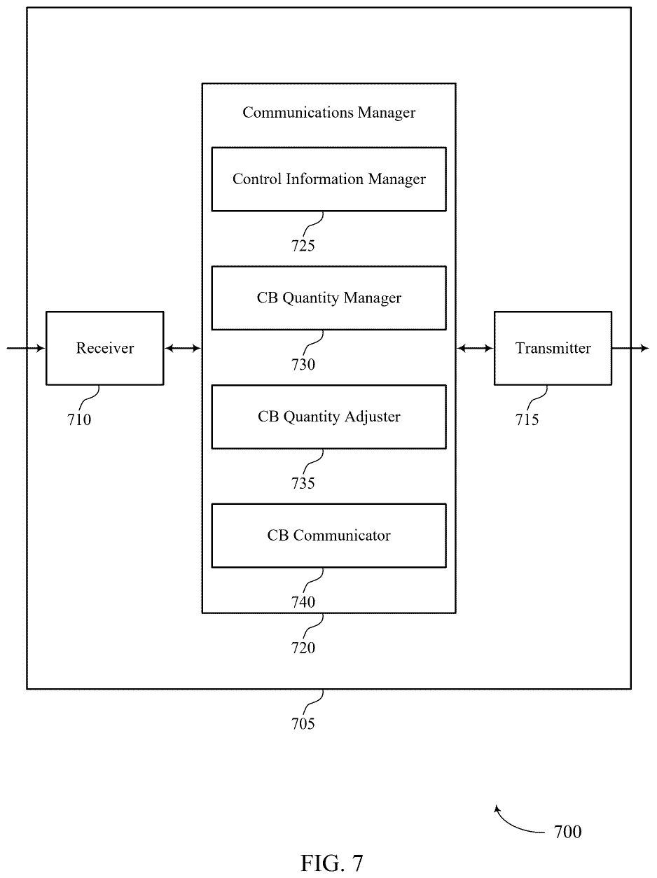

FIG. 7 shows a block diagram 700 of a device 705 that supports transport block segmentation in accordance with one or more aspects of the present disclosure. The device 705 may be an example of aspects of a device 605 or a UE 115 as described herein. The device 705 may include a receiver 710, a transmitter 715, and a communications manager 720. The device 705, or one or more components of the device 705 (e.g., the receiver 710, the transmitter 715, the communications manager 720), may include at least one processor, which may be coupled with at least one memory, to support the described techniques. Each of these components may be in communication with one another (e.g., via one or more buses).

The receiver 710 may provide a means for receiving information such as packets, user data, control information, or any combination thereof associated with various information channels (e.g., control channels, data channels, information channels related to transport block segmentation). Information may be passed on to other components of the device 705. The receiver 710 may utilize a single antenna or a set of multiple antennas.

The transmitter 715 may provide a means for transmitting signals generated by other components of the device 705. For example, the transmitter 715 may transmit information such as packets, user data, control information, or any combination thereof associated with various information channels (e.g., control channels, data channels, information channels related to transport block segmentation). In some examples, the transmitter 715 may be co-located with a receiver 710 in a transceiver module. The transmitter 715 may utilize a single antenna or a set of multiple antennas.

The device 705, or various components thereof, may be an example of means for performing various aspects of transport block segmentation as described herein. For example, the communications manager 720 may include a control information manager 725, a CB quantity manager 730, a CB quantity adjuster 735, a CB communicator 740, or any combination thereof. The communications manager 720 may be an example of aspects of a communications manager 620 as described herein. In some examples, the communications manager 720, or various components thereof, may be configured to perform various operations (e.g., receiving, obtaining, monitoring, outputting, transmitting) using or otherwise in cooperation with the receiver 710, the transmitter 715, or both. For example, the communications manager 720 may receive information from the receiver 710, send information to the transmitter 715, or be integrated in combination with the receiver 710, the transmitter 715, or both to obtain information, output information, or perform various other operations as described herein.

The communications manager 720 may support wireless communications in accordance with examples as disclosed herein. The control information manager 725 is capable of, configured to, or operable to support a means for receiving control information including a resource allocation for communication of a PDSCH. The CB quantity manager 730 is capable of, configured to, or operable to support a means for determining a first quantity of CBs associated with a TBS of the PDSCH, where the TBS is based on the resource allocation. The CB quantity adjuster 735 is capable of, configured to, or operable to support a means for adjusting the first quantity of CBs to a second quantity of CBs based on a quantity of time and frequency resources allocated for the PDSCH, a quantity of spatial layers associated with the communication of the PDSCH, or both. The CB communicator 740 is capable of, configured to, or operable to support a means for communicating, via the quantity of time and frequency resources using the quantity of spatial layers, the second quantity of CBs in accordance with adjusting the first quantity of CBs to the second quantity of CBs.

Additionally, or alternatively, the communications manager 720 may support wireless communications in accordance with examples as disclosed herein. The control information manager 725 is capable of, configured to, or operable to support a means for receiving control information including a resource allocation for communication of a PDSCH. The CB quantity manager 730 is capable of, configured to, or operable to support a means for determining a first quantity of CBs associated with a TBS of the PDSCH, where the TBS is based on the resource allocation. The CB quantity adjuster 735 is capable of, configured to, or operable to support a means for adjusting the first quantity of CBs to a second quantity of CBs of a first size, to a third quantity of CBs of a second size that is less than the first size, or both based on a quantity of time and frequency resources allocated for the PDSCH, on the first quantity of CBs, or both. The CB communicator 740 is capable of, configured to, or operable to support a means for communicating, via the quantity of time and frequency resources using a set of multiple spatial layers, the second quantity of CBs, the third quantity of CBs, or both in accordance with determining the second quantity of CBs and determining the third quantity of CBs.

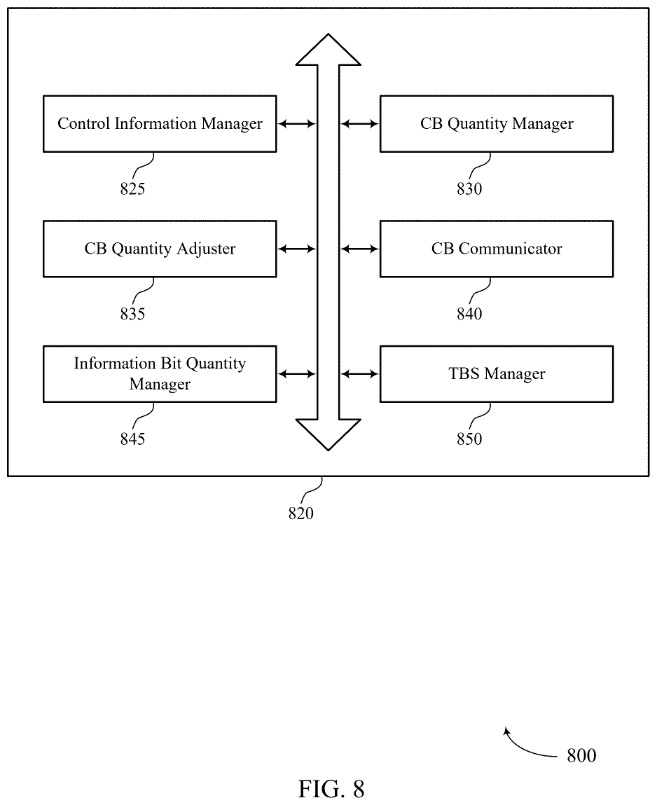

FIG. 8 shows a block diagram 800 of a communications manager 820 that supports transport block segmentation in accordance with one or more aspects of the present disclosure. The communications manager 820 may be an example of aspects of a communications manager 620, a communications manager 720, or both, as described herein. The communications manager 820, or various components thereof, may be an example of means for performing various aspects of transport block segmentation as described herein. For example, the communications manager 820 may include a control information manager 825, a CB quantity manager 830, a CB quantity adjuster 835, a CB communicator 840, an information bit quantity manager 845, a TBS manager 850, or any combination thereof. Each of these components, or components or subcomponents thereof (e.g., one or more processors, one or more memories), may communicate, directly or indirectly, with one another (e.g., via one or more buses).

The communications manager 820 may support wireless communications in accordance with examples as disclosed herein. The control information manager 825 is capable of, configured to, or operable to support a means for receiving control information including a resource allocation for communication of a PDSCH. The CB quantity manager 830 is capable of, configured to, or operable to support a means for determining a first quantity of CBs associated with a TBS of the PDSCH, where the TBS is based on the resource allocation. The CB quantity adjuster 835 is capable of, configured to, or operable to support a means for adjusting the first quantity of CBs to a second quantity of CBs based on a quantity of time and frequency resources allocated for the PDSCH, a quantity of spatial layers associated with the communication of the PDSCH, or both. The CB communicator 840 is capable of, configured to, or operable to support a means for communicating, via the quantity of time and frequency resources using the quantity of spatial layers, the second quantity of CBs in accordance with adjusting the first quantity of CBs to the second quantity of CBs.

In some examples, to support adjusting the first quantity of CBs, the CB quantity adjuster 835 is capable of, configured to, or operable to support a means for decreasing the first quantity of CBs to the second quantity of CBs such that the quantity of time and frequency resources allocated for the PDSCH evenly divides a combination of the second quantity of CBs and the quantity of spatial layer associated with the communication of the PDSCH.

In some examples, to support adjusting the first quantity of CBs, the CB quantity adjuster 835 is capable of, configured to, or operable to support a means for decreasing the first quantity of CBs to a third quantity of CBs. In some examples, to support adjusting the first quantity of CBs, the CB quantity adjuster 835 is capable of, configured to, or operable to support a means for increasing, based on the third quantity of CBs failing to satisfy a threshold, the first quantity of CBs to the second quantity of CBs such that the quantity of time and frequency resources allocated for the PDSCH evenly divides a combination of the second quantity of CBs and the quantity of spatial layers associated with the communication of the PDSCH.

In some examples, the information bit quantity manager 845 is capable of, configured to, or operable to support a means for determining a quantity of information bits associated with the PDSCH based on a quantity of resource elements associated with the PDSCH, a coding rate associated with the PDSCH, a modulation order associated with the PDSCH, the quantity of spatial layers, or a combination thereof. In some examples, the TBS manager 850 is capable of, configured to, or operable to support a means for determining the TBS based on the quantity of information bits, the coding rate, or both, where determining the first quantity of CBs is based on determining the TBS.

In some examples, the coding rate is indicated via the resource allocation.

In some examples, the coding rate is a fixed coding rate value. In some examples, determining the quantity of information bits and the TBS is based on the fixed coding rate value.

In some examples, to support communicating the second quantity of CBS, the CB communicator 840 is capable of, configured to, or operable to support a means for communicating each CB part of the second quantity of CBs via the single OFDM symbol.

In some examples, each CB part of a respective CB of the second quantity of CBs is transmitted via a respective spatial layer of the quantity of spatial layers and at a respective time within the single OFDM symbol.

In some examples, to support communicating the second quantity of CBS, the CB communicator 840 is capable of, configured to, or operable to support a means for communicating at least a first CB part of a first CB of the second quantity of CBs via a first OFDM symbol of the two or more OFDM symbols. In some examples, to support communicating the second quantity of CBs, the CB communicator 840 is capable of, configured to, or operable to support a means for communicating at least a second CB part of the first CB via a second OFDM symbol of the two or more OFDM symbols.

In some examples, the CB communicator 840 is capable of, configured to, or operable to support a means for communicating at least the first CB part of the first CB via a first spatial layer of the quantity of spatial layers. In some examples, the CB communicator 840 is capable of, configured to, or operable to support a means for communicating at least the second CB part of the first CB via a second spatial layer of the quantity of spatial layers.

Additionally, or alternatively, the communications manager 820 may support wireless communications in accordance with examples as disclosed herein. In some examples, the control information manager 825 is capable of, configured to, or operable to support a means for receiving control information including a resource allocation for communication of a PDSCH. In some examples, the CB quantity manager 830 is capable of, configured to, or operable to support a means for determining a first quantity of CBs associated with a TBS of the PDSCH, where the TBS is based on the resource allocation. In some examples, the CB quantity adjuster 835 is capable of, configured to, or operable to support a means for adjusting the first quantity of CBs to a second quantity of CBs of a first size, to a third quantity of CBs of a second size that is less than the first size, or both based on a quantity of time and frequency resources allocated for the PDSCH, on the first quantity of CBs, or both. In some examples, the CB communicator 840 is capable of, configured to, or operable to support a means for communicating, via the quantity of time and frequency resources using a set of multiple spatial layers, the second quantity of CBs, the third quantity of CBs, or both in accordance with determining the second quantity of CBs and determining the third quantity of CBs.

In some examples, to support communicating the second quantity of CBS, the third quantity of CBs, or both, the CB communicator 840 is capable of, configured to, or operable to support a means for communicating the second quantity of CBs prior to the third quantity of CBs in time based on the first size of the second quantity of CBs being greater than the second size of the third quantity of CBS.

In some examples, the CB quantity adjuster 835 is capable of, configured to, or operable to support a means for adjusting the first quantity of CBs to the second quantity of CBs, to the third quantity of CBs, and to a fourth quantity of CBs of a third size based on the first quantity of CBs, the quantity of time and frequency resources, or both, where the third size is less than the first size and greater than the second size. In some examples, the CB communicator 840 is capable of, configured to, or operable to support a means for communicating, via the quantity of time and frequency resources using a set of multiple spatial layers, the fourth quantity of CBs in accordance with the adjusting.

In some examples, the information bit quantity manager 845 is capable of, configured to, or operable to support a means for determining a quantity of information bits associated with the PDSCH based on a quantity of resource elements associated with the PDSCH, a coding rate associated with the PDSCH, a modulation order associated with the PDSCH, the quantity of spatial layers, or a combination thereof. In some examples, the TBS manager 850 is capable of, configured to, or operable to support a means for determining the TBS based on the quantity of information bits, the coding rate, or both, where determining the first quantity of CBs is based on determining the TBS.

In some examples, to support communicating, the CB communicator 840 is capable of, configured to, or operable to support a means for communicating each CB part of the second quantity of CBs, each CB part of the third quantity of CBs, or both via the single OFDM symbol.

In some examples, each CB part of a respective CB of the second quantity of CBs is transmitted via a respective spatial layer of the quantity of spatial layers and at a respective time within the single OFDM symbol. In some examples, each CB part of a respective CB of the third quantity of CBs is transmitted via a respective spatial layer of the quantity of spatial layers and at a respective time within the single OFDM symbol.

In some examples, to support communicating, the CB communicator 840 is capable of, configured to, or operable to support a means for communicating each CB part of a first CB of the second quantity of CBs via the two or more OFDM symbols, where one or more CB parts of the first CB are communicated within a respective OFDM symbol of the two or more OFDM symbols. In some examples, to support communicating, the CB communicator 840 is capable of, configured to, or operable to support a means for communicating each CB part of a first CB of the third quantity of CBs via the two or more OFDM symbols, where one or more CB parts of the first CB are communicated via a respective OFDM symbol of the two or more OFDM symbols.

In some examples, to support communicating the second quantity of CBS, the CB communicator 840 is capable of, configured to, or operable to support a means for communicating at least a first CB part of the first CB of the second quantity of CBs via a first spatial layer of the quantity of spatial layers and via a first OFDM symbol of the two or more OFDM symbols. In some examples, to support communicating the second quantity of CBs, the CB communicator 840 is capable of, configured to, or operable to support a means for communicating at least a second CB part of the first CB of the second quantity of CBs via a second spatial layer of the quantity of spatial layers and via a second OFDM symbol of the two or more OFDM symbols.

In some examples, to support communicating the third quantity of CBs, the CB communicator 840 is capable of, configured to, or operable to support a means for communicating at least a first CB part of the first CB of the third quantity of CBs via a first spatial layer of the quantity of spatial layers and via a first OFDM symbol of the two or more OFDM symbols. In some examples, to support communicating the third quantity of CBs, the CB communicator 840 is capable of, configured to, or operable to support a means for communicating at least a second CB part of the first CB of the third quantity of CBs via a second spatial layer of the quantity of spatial layers and via a second OFDM symbol of the two or more OFDM symbols.

In some examples, the second quantity of CBs is greater than the third quantity of CBs.

In some examples, the first size of the second quantity of CBs includes a first quantity of information bits. In some examples, the second size of the third quantity of CBs includes a second quantity of information bits. In some examples, the first quantity of information bits is greater than the second quantity of information bits.

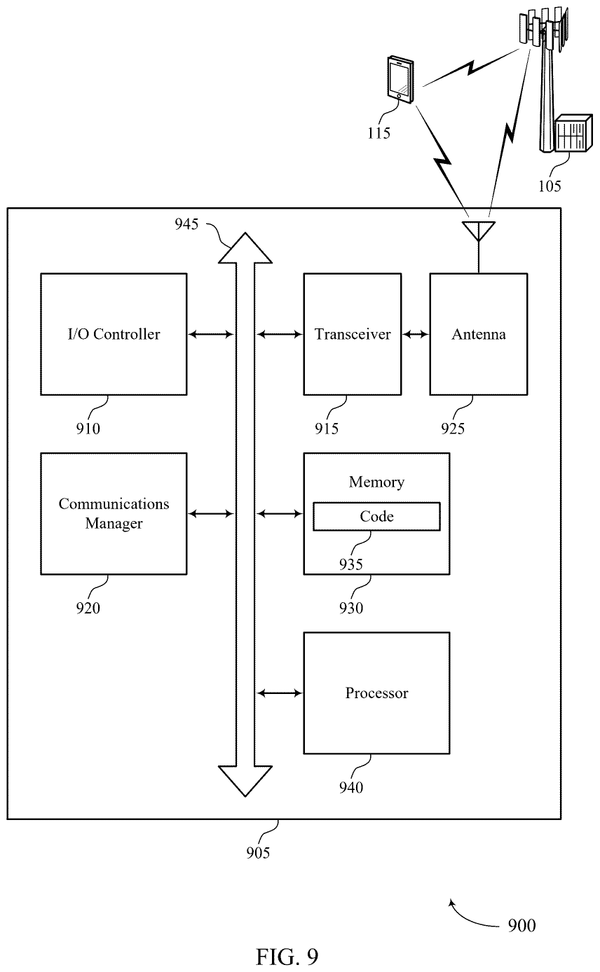

FIG. 9 shows a diagram of a system 900 including a device 905 that supports transport block segmentation in accordance with one or more aspects of the present disclosure. The device 905 may be an example of or include components of a device 605, a device 705, or a UE 115 as described herein. The device 905 may communicate (e.g., wirelessly) with one or more other devices (e.g., network entities 105, UEs 115, or a combination thereof). The device 905 may include components for bi-directional voice and data communications including components for transmitting and receiving communications, such as a communications manager 920, an input/output (I/O) controller, such as an I/O controller 910, a transceiver 915, one or more antennas 925, at least one memory 930, code 935, and at least one processor 940. These components may be in electronic communication or otherwise coupled (e.g., operatively, communicatively, functionally, electronically, electrically) via one or more buses (e.g., a bus 945).

The I/O controller 910 may manage input and output signals for the device 905. The I/O controller 910 may also manage peripherals not integrated into the device 905. In some cases, the I/O controller 910 may represent a physical connection or port to an external peripheral. In some cases, the I/O controller 910 may utilize an operating system such as iOS®, ANDROID®, MS-DOS®, MS-WINDOWS®, OS/2®, UNIX®, LINUX®, or another known operating system. Additionally, or alternatively, the I/O controller 910 may represent or interact with a modem, a keyboard, a mouse, a touchscreen, or a similar device. In some cases, the I/O controller 910 may be implemented as part of one or more processors, such as the at least one processor 940. In some cases, a user may interact with the device 905 via the I/O controller 910 or via hardware components controlled by the I/O controller 910.

In some cases, the device 905 may include a single antenna. However, in some other cases, the device 905 may have more than one antenna, which may be capable of concurrently transmitting or receiving multiple wireless transmissions. The transceiver 915 may communicate bi-directionally via the one or more antennas 925 using wired or wireless links as described herein. For example, the transceiver 915 may represent a wireless transceiver and may communicate bi-directionally with another wireless transceiver. The transceiver 915 may also include a modem to modulate the packets, to provide the modulated packets to one or more antennas 925 for transmission, and to demodulate packets received from the one or more antennas 925. The transceiver 915, or the transceiver 915 and one or more antennas 925, may be an example of a transmitter 615, a transmitter 715, a receiver 610, a receiver 710, or any combination thereof or component thereof, as described herein.

The at least one memory 930 may include random access memory (RAM) and read-only memory (ROM). The at least one memory 930 may store computer-readable, computer-executable, or processor-executable code, such as the code 935. The code 935 may include instructions that, when executed by the at least one processor 940, cause the device 905 to perform various functions described herein. The code 935 may be stored in a non-transitory computer-readable medium such as system memory or another type of memory. In some cases, the code 935 may not be directly executable by the at least one processor 940 but may cause a computer (e.g., when compiled and executed) to perform functions described herein. In some cases, the at least one memory 930 may include, among other things, a basic I/O system (BIOS) which may control basic hardware or software operation such as the interaction with peripheral components or devices.

The at least one processor 940 may include one or more intelligent hardware devices (e.g., one or more general-purpose processors, one or more DSPs, one or more CPUs, one or more GPUs, one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 940 may be configured to operate a memory array using a memory controller. In some other cases, a memory controller may be integrated into the at least one processor 940. The at least one processor 940 may be configured to execute computer-readable instructions stored in a memory (e.g., the at least one memory 930) to cause the device 905 to perform various functions (e.g., functions or tasks supporting transport block segmentation). For example, the device 905 or a component of the device 905 may include at least one processor 940 and at least one memory 930 coupled with or to the at least one processor 940, the at least one processor 940 and the at least one memory 930 configured to perform various functions described herein.

In some examples, the at least one processor 940 may include multiple processors and the at least one memory 930 may include multiple memories. One or more of the multiple processors may be coupled with one or more of the multiple memories, which may, individually or collectively, be configured to perform various functions described herein. In some examples, the at least one processor 940 may be a component of a processing system, which may refer to a system (such as a series) of machines, circuitry (including, for example, one or both of processor circuitry (which may include the at least one processor 940) and memory circuitry (which may include the at least one memory 930)), or components, that receives or obtains inputs and processes the inputs to produce, generate, or obtain a set of outputs. The processing system may be configured to perform one or more of the functions described herein. For example, the at least one processor 940 or a processing system including the at least one processor 940 may be configured to, configurable to, or operable to cause the device 905 to perform one or more of the functions described herein. Further, as described herein, being “configured to,” being “configurable to,” and being “operable to” may be used interchangeably and may be associated with a capability, when executing code 935 (e.g., processor-executable code) stored in the at least one memory 930 or otherwise, to perform one or more of the functions described herein.

The communications manager 920 may support wireless communications in accordance with examples as disclosed herein. For example, the communications manager 920 is capable of, configured to, or operable to support a means for receiving control information including a resource allocation for communication of a PDSCH. The communications manager 920 is capable of, configured to, or operable to support a means for determining a first quantity of CBs associated with a TBS of the PDSCH, where the TBS is based on the resource allocation. The communications manager 920 is capable of, configured to, or operable to support a means for adjusting the first quantity of CBs to a second quantity of CBs based on a quantity of time and frequency resources allocated for the PDSCH, a quantity of spatial layers associated with the communication of the PDSCH, or both. The communications manager 920 is capable of, configured to, or operable to support a means for communicating, via the quantity of time and frequency resources using the quantity of spatial layers, the second quantity of CBs in accordance with adjusting the first quantity of CBs to the second quantity of CBS.

Additionally, or alternatively, the communications manager 920 may support wireless communications in accordance with examples as disclosed herein. For example, the communications manager 920 is capable of, configured to, or operable to support a means for receiving control information including a resource allocation for communication of a PDSCH. The communications manager 920 is capable of, configured to, or operable to support a means for determining a first quantity of CBs associated with a TBS of the PDSCH, where the TBS is based on the resource allocation. The communications manager 920 is capable of, configured to, or operable to support a means for adjusting the first quantity of CBs to a second quantity of CBs of a first size, to a third quantity of CBs of a second size that is less than the first size, or both based on a quantity of time and frequency resources allocated for the PDSCH, on the first quantity of CBs, or both. The communications manager 920 is capable of, configured to, or operable to support a means for communicating, via the quantity of time and frequency resources using a set of multiple spatial layers, the second quantity of CBs, the third quantity of CBs, or both in accordance with determining the second quantity of CBs and determining the third quantity of CBS.

By including or configuring the communications manager 920 in accordance with examples as described herein, the device 905 may support techniques for improved communication reliability, more efficient utilization of communication resources, improved coordination between devices, and improved utilization of processing capability.

In some examples, the communications manager 920 may be configured to perform various operations (e.g., receiving, monitoring, transmitting) using or otherwise in cooperation with the transceiver 915, the one or more antennas 925, or any combination thereof. Although the communications manager 920 is illustrated as a separate component, in some examples, one or more functions described with reference to the communications manager 920 may be supported by or performed by the at least one processor 940, the at least one memory 930, the code 935, or any combination thereof. For example, the code 935 may include instructions executable by the at least one processor 940 to cause the device 905 to perform various aspects of transport block segmentation as described herein, or the at least one processor 940 and the at least one memory 930 may be otherwise configured to, individually or collectively, perform or support such operations.

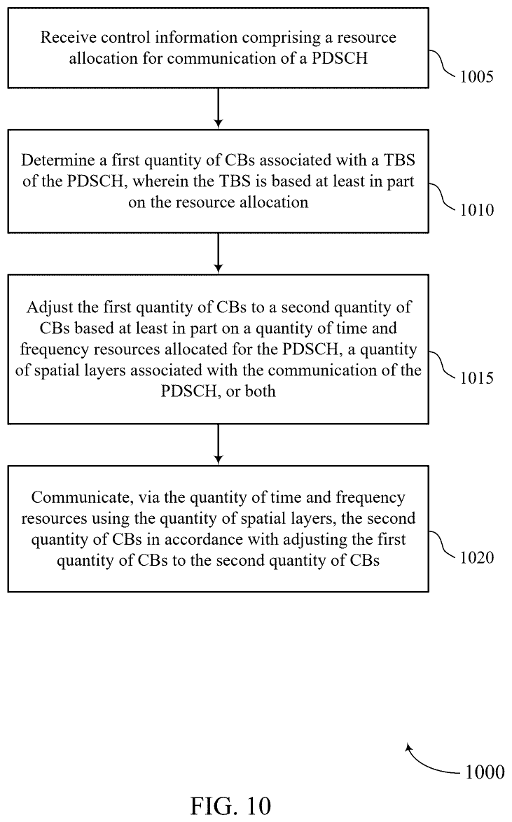

FIG. 10 shows a flowchart illustrating a method 1000 that supports transport block segmentation in accordance with one or more aspects of the present disclosure. The operations of the method 1000 may be implemented by a UE or its components as described herein. For example, the operations of the method 1000 may be performed by a UE 115 as described with reference to FIGS. 1 through 9. In some examples, a UE may execute a set of instructions to control the functional elements of the UE to perform the described functions. Additionally, or alternatively, the UE may perform aspects of the described functions using special-purpose hardware.

At 1005, the method may comprise receiving control information including a resource allocation for communication of a PDSCH. The operations of 1005 may be performed in accordance with examples as disclosed herein. In some examples, aspects of the operations of 1005 may be performed by a control information manager 825 as described with reference to FIG. 8.

At 1010, the method may comprise determining a first quantity of CBs associated with a TBS of the PDSCH, wherein the TBS is based at least in part on the resource allocation. The operations of 1010 may be performed in accordance with examples as disclosed herein. In some examples, aspects of the operations of 1010 may be performed by a CB quantity manager 830 as described with reference to FIG. 8.

At 1015, the method may comprise adjusting the first quantity of CBs to a second quantity of CBs based at least in part on a quantity of time and frequency resources allocated for the PDSCH, a quantity of spatial layers associated with the communication of the PDSCH, or both. The operations of 1015 may be performed in accordance with examples as disclosed herein. In some examples, aspects of the operations of 1015 may be performed by a CB quantity adjuster 835 as described with reference to FIG. 8.

At 1020, the method may comprise communicating, via the quantity of time and frequency resources using the quantity of spatial layers, the second quantity of CBs in accordance with adjusting the first quantity of CBs to the second quantity of CBs. The operations of 1020 may be performed in accordance with examples as disclosed herein. In some examples, aspects of the operations of 1020 may be performed by a CB communicator 840 as described with reference to FIG. 8.

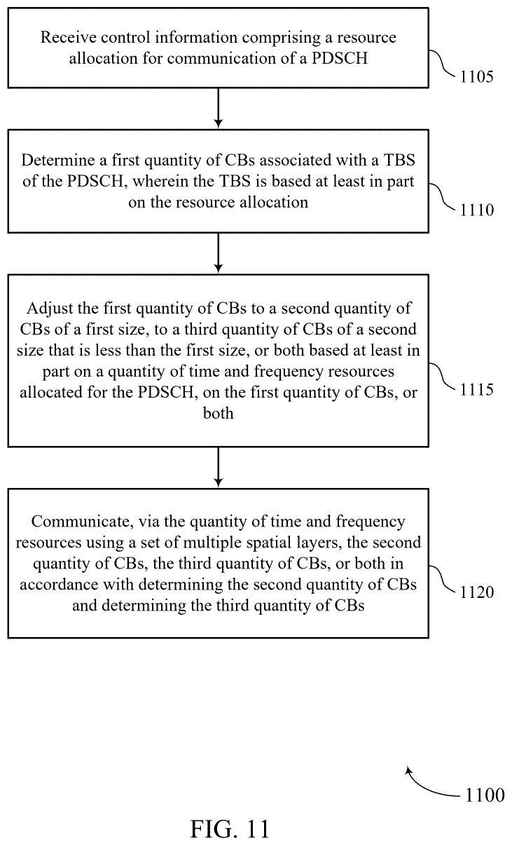

FIG. 11 shows a flowchart illustrating a method 1100 that supports transport block segmentation in accordance with one or more aspects of the present disclosure. The operations of the method 1100 may be implemented by a UE or its components as described herein. For example, the operations of the method 1100 may be performed by a UE 115 as described with reference to FIGS. 1 through 9. In some examples, a UE may execute a set of instructions to control the functional elements of the UE to perform the described functions. Additionally, or alternatively, the UE may perform aspects of the described functions using special-purpose hardware.

At 1105, the method may comprise receiving control information comprising a resource allocation for communication of a PDSCH. The operations of 1105 may be performed in accordance with examples as disclosed herein. In some examples, aspects of the operations of 1105 may be performed by a control information manager 825 as described with reference to FIG. 8.

At 1110, the method may comprise determining a first quantity of CBs associated with a TBS of the PDSCH, wherein the TBS is based at least in part on the resource allocation. The operations of 1110 may be performed in accordance with examples as disclosed herein. In some examples, aspects of the operations of 1110 may be performed by a CB quantity manager 830 as described with reference to FIG. 8.

At 1115, the method may comprise adjusting the first quantity of CBs to a second quantity of CBs of a first size, to a third quantity of CBs of a second size that is less than the first size, or both based at least in part on a quantity of time and frequency resources allocated for the PDSCH, on the first quantity of CBs, or both. The operations of 1115 may be performed in accordance with examples as disclosed herein. In some examples, aspects of the operations of 1115 may be performed by a CB quantity adjuster 835 as described with reference to FIG. 8.

At 1120, the method may comprise communicating, via the quantity of time and frequency resources using a set of multiple spatial layers, the second quantity of CBs, the third quantity of CBs, or both in accordance with determining the second quantity of CBs and determining the third quantity of CBs. The operations of 1120 may be performed in accordance with examples as disclosed herein. In some examples, aspects of the operations of 1120 may be performed by a CB communicator 840 as described with reference to FIG. 8.

The following provides an overview of aspects of the present disclosure:
Aspect 1: A method for wireless communications at a UE, comprising: receiving control information comprising a resource allocation for communication of a PDSCH; determining a first quantity of CBs associated with a TBS of the PDSCH, wherein the TBS is based at least in part on the resource allocation; adjusting the first quantity of CBs to a second quantity of CBs based at least in part on a quantity of time and frequency resources allocated for the PDSCH, a quantity of spatial layers associated with the communication of the PDSCH, or both; and communicating, via the quantity of time and frequency resources using the quantity of spatial layers, the second quantity of CBs in accordance with adjusting the first quantity of CBs to the second quantity of CBs.
Aspect 2: The method of aspect 1, wherein adjusting the first quantity of CBs further comprises: decreasing the first quantity of CBs to the second quantity of CBs such that the quantity of time and frequency resources allocated for the PDSCH evenly divides a combination of the second quantity of CBs and the quantity of spatial layer associated with the communication of the PDSCH.
Aspect 3: The method of any of aspects 1 through 2, wherein adjusting the first quantity of CBs further comprises: decreasing the first quantity of CBs to a third quantity of CBs; and increasing, based at least in part on the third quantity of CBs failing to satisfy a threshold, the first quantity of CBs to the second quantity of CBs such that the quantity of time and frequency resources allocated for the PDSCH evenly divides a combination of the second quantity of CBs and the quantity of spatial layers associated with the communication of the PDSCH.
Aspect 4: The method of any of aspects 1 through 3, further comprising: determining a quantity of information bits associated with the PDSCH based at least in part on a quantity of resource elements associated with the PDSCH, a coding rate associated with the PDSCH, a modulation order associated with the PDSCH, the quantity of spatial layers, or a combination thereof; and determining the TBS based at least in part on the quantity of information bits, the coding rate, or both, wherein determining the first quantity of CBs is based at least in part on determining the TBS.
Aspect 5: The method of aspect 4, wherein the coding rate is indicated via the resource allocation.
Aspect 6: The method of any of aspects 4 through 5, wherein the coding rate is a fixed coding rate value, and determining the quantity of information bits and the TBS is based at least in part on the fixed coding rate value.
Aspect 7: The method of any of aspects 1 through 6, wherein time resources of the quantity of time and frequency resources span a single OFDM symbol, wherein each CB of the second quantity of CBs is divided into two or more CB parts, and wherein communicating the second quantity of CBs comprises: communicating each CB part of the second quantity of CBs via the single OFDM symbol.
Aspect 8: The method of aspect 7, wherein each CB part of a respective CB of the second quantity of CBs is transmitted via a respective spatial layer of the quantity of spatial layers and at a respective time within the single OFDM symbol.
Aspect 9: The method of any of aspects 1 through 6, wherein time resources of the quantity of time and frequency resources span two or more OFDM symbols, wherein each CB of the second quantity of CBs is divided into two or more CB parts, and wherein communicating the second quantity of CBs comprises: communicating at least a first CB part of a first CB of the second quantity of CBs via a first OFDM symbol the two or more OFDM symbols; and communicating at least a second CB part of the first CB via a second OFDM symbol of the two or more OFDM symbols.
Aspect 10: The method of aspect 9, further comprising: communicating at least the first CB part of the first CB via a first spatial layer of the quantity of spatial layers; and communicating at least the second CB part of the first CB via a second spatial layer of the quantity of spatial layers.
Aspect 11: A method for wireless communications at a UE, comprising: receiving control information comprising a resource allocation for communication of a PDSCH; determining a first quantity of CBs associated with a TBS of the PDSCH, wherein the TBS is based at least in part on the resource allocation; adjusting the first quantity of CBs to a second quantity of CBs of a first size, to a third quantity of CBs of a second size that is less than the first size, or both based at least in part on a quantity of time and frequency resources allocated for the PDSCH, on the first quantity of CBs, or both; and communicating, via the quantity of time and frequency resources using a plurality of spatial layers, the second quantity of CBs, the third quantity of CBs, or both in accordance with determining the second quantity of CBs and determining the third quantity of CBs.
Aspect 12: The method of aspect 11, wherein communicating the second quantity of CBs, the third quantity of CBs, or both further comprises: communicating the second quantity of CBs prior to the third quantity of CBs in time based at least in part on the first size of the second quantity of CBs being greater than the second size of the third quantity of CBs.
Aspect 13: The method of any of aspects 11 through 12, further comprising: adjusting the first quantity of CBs to the second quantity of CBs, to the third quantity of CBs, and to a fourth quantity of CBs of a third size based at least in part on the first quantity of CBs, the quantity of time and frequency resources, or both, wherein the third size is less than the first size and greater than the second size; and communicating, via the quantity of time and frequency resources using a plurality of spatial layers, the fourth quantity of CBs in accordance with the adjusting.
Aspect 14: The method of any of aspects 11 through 13, further comprising: determining a quantity of information bits associated with the PDSCH based at least in part on a quantity of resource elements associated with the PDSCH, a coding rate associated with the PDSCH, a modulation order associated with the PDSCH, the quantity of spatial layers, or a combination thereof; and determining the TBS based at least in part on the quantity of information bits, the coding rate, or both, wherein determining the first quantity of CBs is based at least in part on determining the TBS.
Aspect 15: The method of any of aspects 11 through 14, wherein time resources of the quantity of time and frequency resources span a single OFDM symbol, wherein each CB of the second quantity of CBs, each CB of the third quantity of CBS, or both are divided into two or more CB parts, and wherein the communicating comprises: communicating each CB part of the second quantity of CBs, each CB part of the third quantity of CBs, or both via the single OFDM symbol.
Aspect 16: The method of aspect 15, wherein each CB part of a respective CB of the second quantity of CBs is transmitted via a respective spatial layer of the quantity of spatial layers and at a respective time within the single OFDM symbol, each CB part of a respective CB of the third quantity of CBs is transmitted via a respective spatial layer of the quantity of spatial layers and at a respective time within the single OFDM symbol, or both.
Aspect 17: The method of any of aspects 11 through 14, wherein time resources of the quantity of time and frequency resources span two or more OFDM symbols, wherein each CB of the second quantity of CBs, each CB of the third quantity of CBs, or both are divided into two or more CB parts, and wherein the communicating comprises: communicating each CB part of a first CB of the second quantity of CBs via the two or more OFDM symbols, wherein one or more CB parts of the first CB are communicated within a respective OFDM symbol of the two or more OFDM symbols; and communicating each CB part of a first CB of the third quantity of CBs via the two or more OFDM symbols, wherein one or more CB parts of the first CB are communicated via a respective OFDM symbol of the two or more OFDM symbols.
Aspect 18: The method of aspect 17, wherein communicating the second quantity of CBs further comprises: communicating at least a first CB part of the first CB of the second quantity of CBs via a first spatial layer of the quantity of spatial layers and via a first OFDM symbol of the two or more OFDM symbols; and communicating at least a second CB part of the first CB of the second quantity of CBs via a second spatial layer of the quantity of spatial layers and via a second OFDM symbol of the two or more OFDM symbols.
Aspect 19: The method of any of aspects 17 through 18, wherein communicating the third quantity of CBs further comprises: communicating at least a first CB part of the first CB of the third quantity of CBs via a first spatial layer of the quantity of spatial layers and via a first OFDM symbol of the two or more OFDM symbols; and communicating at least a second CB part of the first CB of the third quantity of CBs via a second spatial layer of the quantity of spatial layers and via a second OFDM symbol of the two or more OFDM symbols.
Aspect 20: The method of any of aspects 11 through 19, wherein the second quantity of CBs is greater than the third quantity of CBs.
Aspect 21: The method of any of aspects 11 through 20, wherein the first size of the second quantity of CBs comprises a first quantity of information bits, and the second size of the third quantity of CBs comprises a second quantity of information bits, and the first quantity of information bits is greater than the second quantity of information bits.
Aspect 22: A UE for wireless communications, comprising one or more memories storing processor-executable code, and one or more processors coupled with (e.g., operatively, communicatively, functionally, electronically, or electrically) the one or more memories and individually or collectively operable to execute the code (e.g., directly, indirectly, after pre-processing, without pre-processing) to cause the UE to perform a method of any of aspects 1 through 10.
Aspect 23: A UE for wireless communications, comprising at least one means for performing a method of any of aspects 1 through 10.
Aspect 24: A non-transitory computer-readable medium storing code for wireless communications, the code comprising instructions executable by one or more processors (e.g., directly, indirectly, after pre-processing, without pre-processing) to perform a method of any of aspects 1 through 10.
Aspect 25: A UE for wireless communications, comprising one or more memories storing processor-executable code, and one or more processors coupled with (e.g., operatively, communicatively, functionally, electronically, or electrically) the one or more memories and individually or collectively operable to execute the code (e.g., directly, indirectly, after pre-processing, without pre-processing) to cause the UE to perform a method of any of aspects 11 through 21.
Aspect 26: A UE for wireless communications, comprising at least one means for performing a method of any of aspects 11 through 21.
Aspect 27: A non-transitory computer-readable medium storing code for wireless communications, the code comprising instructions executable by one or more processors (e.g., directly, indirectly, after pre-processing, without pre-processing) to perform a method of any of aspects 11 through 21.

It should be noted that the methods described herein describe possible implementations. The operations and the steps may be rearranged or otherwise modified and other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies, including future systems and radio technologies, not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, a GPU, an NPU, an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, or any combination thereof. Software shall be construed broadly to mean instructions, instruction sets, code, code segments, program code, programs, subprograms, software modules, applications, software applications, software packages, routines, subroutines, objects, executables, threads of execution, procedures, or functions, whether referred to as software, firmware, middleware, microcode, hardware description language, or otherwise. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, phase change memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk, and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., including a list of items prefaced by a phrase such as “at least one of” or “one or more of”) indicates an inclusive list such that, for example, a list of at least one of A, B, or C means, e.g., A or B or C or AB or AC or BC or ABC (e.g., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.” As used herein, the term “and/or,” when used in a list of two or more items, means that any one of the listed items can be employed by itself, or any combination of two or more of the listed items can be employed. For example, if a composition is described as containing components A, B, and/or C, the composition can contain A alone; B alone; C alone; A and B in combination; A and C in combination; B and C in combination; or A, B, and C in combination.

As used herein, including in the claims, the article “a” before a noun is open-ended and understood to refer to “at least one” of those nouns or “one or more” of those nouns. Thus, the terms “a,” “at least one,” “one or more,” and “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” or “identify” or “identifying” encompasses a variety of actions and, therefore, “determining” or “identifying” can include calculating, computing, processing, deriving, investigating, looking up (such as via looking up in a table, a database or another data structure), or ascertaining. Also, “determining” or “identifying” can include receiving (such as receiving information or signaling, e.g., receiving information or signaling for determining, receiving information or signaling for identifying), or accessing (such as accessing data in a memory, or accessing information). Also, “determining” or “identifying” can include resolving, obtaining, selecting, choosing, establishing and other such similar actions. In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label or other subsequent reference label.

The description set forth herein, in connection with the appended drawings, describes example configurations and does not represent all the examples that may be implemented or that are within the scope of the claims. The term “example” used herein means “serving as an example, instance, or illustration” and not “preferred” or “advantageous over other examples.” The detailed description includes specific details for the purpose of providing an understanding of the described techniques. These techniques, however, may be practiced without these specific details. In some figures, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE), comprising:
one or more memories storing processor-executable code; and
one or more processors coupled with the one or more memories and individually or collectively operable to execute the code to cause the UE to:
receive control information comprising a resource allocation for communication of a physical downlink shared channel;
determine a first quantity of code blocks associated with a transport block size of the physical downlink shared channel, wherein the transport block size is based at least in part on the resource allocation;
adjust the first quantity of code blocks to a second quantity of code blocks based at least in part on a quantity of time and frequency resources allocated for the physical downlink shared channel, a quantity of spatial layers associated with the communication of the physical downlink shared channel, or both; and
communicate, via the quantity of time and frequency resources using the quantity of spatial layers, the second quantity of code blocks in accordance with adjusting the first quantity of code blocks to the second quantity of code blocks.

2. The UE of claim 1, wherein, to adjust the first quantity of code blocks, the one or more processors are individually or collectively further operable to execute the code to cause the UE to:
decrease the first quantity of code blocks to the second quantity of code blocks such that the quantity of time and frequency resources allocated for the physical downlink shared channel evenly divides a combination of the second quantity of code blocks and the quantity of spatial layer associated with the communication of the physical downlink shared channel.

3. The UE of claim 1, wherein, to adjust the first quantity of code blocks, the one or more processors are individually or collectively further operable to execute the code to cause the UE to:
decrease the first quantity of code blocks to a third quantity of code blocks; and
increase, based at least in part on the third quantity of code blocks failing to satisfy a threshold, the first quantity of code blocks to the second quantity of code blocks such that the quantity of time and frequency resources allocated for the physical downlink shared channel evenly divides a combination of the second quantity of code blocks and the quantity of spatial layers associated with the communication of the physical downlink shared channel.

4. The UE of claim 1, wherein the one or more processors are individually or collectively further operable to execute the code to cause the UE to:
determine a quantity of information bits associated with the physical downlink shared channel based at least in part on a quantity of resource elements associated with the physical downlink shared channel, a coding rate associated with the physical downlink shared channel, a modulation order associated with the physical downlink shared channel, the quantity of spatial layers, or a combination thereof; and
determine the transport block size based at least in part on the quantity of information bits, the coding rate, or both, wherein determining the first quantity of code blocks is based at least in part on determining the transport block size.

5. The UE of claim 4, wherein the coding rate is indicated via the resource allocation.

6. The UE of claim 4, wherein:
the coding rate is a fixed coding rate value, and
determining the quantity of information bits and the transport block size is based at least in part on the fixed coding rate value.

7. The UE of claim 1, wherein time resources of the quantity of time and frequency resources span a single orthogonal frequency division multiplexing symbol, wherein each code block of the second quantity of code blocks is divided into two or more code block parts, and wherein, to communicate the second quantity of code blocks, the one or more processors are individually or collectively operable to execute the code to cause the UE to:
communicate each code block part of the second quantity of code blocks via a single orthogonal frequency division multiplexing symbol.

8. The UE of claim 7, wherein each code block part of a respective code block of the second quantity of code blocks is transmitted via a respective spatial layer of the quantity of spatial layers and at a respective time within the single orthogonal frequency division multiplexing symbol.

9. The UE of claim 1, wherein time resources of the quantity of time and frequency resources span two or more orthogonal frequency division multiplexing symbols, wherein each code block of the second quantity of code blocks is divided into two or more code block parts, and wherein, to communicate the second quantity of code blocks, the one or more processors are individually or collectively operable to execute the code to cause the UE to:
communicate at least a first code block part of a first code block of the second quantity of code blocks via a first orthogonal frequency division multiplexing symbol of the two or more orthogonal frequency division multiplexing symbols; and
communicate at least a second code block part of the first code block via a second orthogonal frequency division multiplexing symbol of the two or more orthogonal frequency division multiplexing symbols.

10. The UE of claim 9, wherein the one or more processors are individually or collectively further operable to execute the code to cause the UE to:
communicate at least the first code block part of the first code block via a first spatial layer of the quantity of spatial layers; and
communicate at least the second code block part of the first code block via a second spatial layer of the quantity of spatial layers.

11. A user equipment (UE), comprising:
one or more memories storing processor-executable code; and
one or more processors coupled with the one or more memories and individually or collectively operable to execute the code to cause the UE to:
receive control information comprising a resource allocation for communication of a physical downlink shared channel;
determine a first quantity of code blocks associated with a transport block size of the physical downlink shared channel, wherein the transport block size is based at least in part on the resource allocation;
adjust the first quantity of code blocks to a second quantity of code blocks of a first size, to a third quantity of code blocks of a second size that is less than the first size, or both based at least in part on a quantity of time and frequency resources allocated for the physical downlink shared channel, on the first quantity of code blocks, or both; and
communicate, via the quantity of time and frequency resources using a plurality of spatial layers, the second quantity of code blocks, the third quantity of code blocks, or both in accordance with determining the second quantity of code blocks and determining the third quantity of code blocks.

12. The UE of claim 11, wherein, to communicate the second quantity of code blocks, the third quantity of code blocks, or both, the one or more processors are individually or collectively further operable to execute the code to cause the UE to:
communicate the second quantity of code blocks prior to the third quantity of code blocks in time based at least in part on the first size of the second quantity of code blocks being greater than the second size of the third quantity of code blocks.

13. The UE of claim 11, wherein the one or more processors are individually or collectively further operable to execute the code to cause the UE to:
adjust the first quantity of code blocks to the second quantity of code blocks, to the third quantity of code blocks, and to a fourth quantity of code blocks of a third size based at least in part on the first quantity of code blocks, the quantity of time and frequency resources, or both, wherein the third size is less than the first size and greater than the second size; and
communicate, via the quantity of time and frequency resources using a plurality of spatial layers, the fourth quantity of code blocks in accordance with the adjusting.

14. The UE of claim 11, wherein the one or more processors are individually or collectively further operable to execute the code to cause the UE to:
determine a quantity of information bits associated with the physical downlink shared channel based at least in part on a quantity of resource elements associated with the physical downlink shared channel, a coding rate associated with the physical downlink shared channel, a modulation order associated with the physical downlink shared channel, the quantity of spatial layers, or a combination thereof; and
determine the transport block size based at least in part on the quantity of information bits, the coding rate, or both, wherein determining the first quantity of code blocks is based at least in part on determining the transport block size.

15. The UE of claim 11, wherein time resources of the quantity of time and frequency resources span a single orthogonal frequency division multiplexing symbol, wherein each code block of the second quantity of code blocks, each code block of the third quantity of code blocks, or both are divided into two or more code block parts, and wherein, to communicate, the one or more processors are individually or collectively operable to execute the code to cause the UE to:
communicate each code block part of the second quantity of code blocks, each code block part of the third quantity of code blocks, or both via the single orthogonal frequency division multiplexing symbol.

16. The UE of claim 15, wherein:
each code block part of a respective code block of the second quantity of code blocks is transmitted via a respective spatial layer of the quantity of spatial layers and at a respective time within the single orthogonal frequency division multiplexing symbol, and
each code block part of a respective code block of the third quantity of code blocks is transmitted via a respective spatial layer of the quantity of spatial layers and at a respective time within the single orthogonal frequency division multiplexing symbol.

17. The UE of claim 11, wherein time resources of the quantity of time and frequency resources span two or more orthogonal frequency division multiplexing symbols, wherein each code block of the second quantity of code blocks, each code block of the third quantity of code blocks, or both are divided into two or more code block parts, and wherein, to communicate, the one or more processors are individually or collectively operable to execute the code to cause the UE to:
communicate each code block part of a first code block of the second quantity of code blocks via the two or more orthogonal frequency division multiplexing symbols, wherein one or more code block parts of the first code block are communicated within a respective orthogonal frequency division multiplexing symbol of the two or more orthogonal frequency division multiplexing symbols; and
communicate each code block part of a first code block of the third quantity of code blocks via the two or more orthogonal frequency division multiplexing symbols, wherein one or more code block parts of the first code block are communicated via a respective orthogonal frequency division multiplexing symbol of the two or more orthogonal frequency division multiplexing symbols.

18. The UE of claim 17, wherein, to communicate the second quantity of code blocks, the one or more processors are individually or collectively further operable to execute the code to cause the UE to:
communicate at least a first code block part of the first code block of the second quantity of code blocks via a first spatial layer of the quantity of spatial layers and via a first orthogonal frequency division multiplexing symbol of the two or more orthogonal frequency division multiplexing symbols; and
communicate at least a second code block part of the first code block of the second quantity of code blocks via a second spatial layer of the quantity of spatial layers and via a second orthogonal frequency division multiplexing symbol of the two or more orthogonal frequency division multiplexing symbols.

19. The UE of claim 17, wherein, to communicate the third quantity of code blocks, the one or more processors are individually or collectively further operable to execute the code to cause the UE to:
communicate at least a first code block part of the first code block of the third quantity of code blocks via a first spatial layer of the quantity of spatial layers and via a first orthogonal frequency division multiplexing symbol of the two or more orthogonal frequency division multiplexing symbols; and
communicate at least a second code block part of the first code block of the third quantity of code blocks via a second spatial layer of the quantity of spatial layers and via a second orthogonal frequency division multiplexing symbol of the two or more orthogonal frequency division multiplexing symbols.

20. The UE of claim 11, wherein the second quantity of code blocks is greater than the third quantity of code blocks.

21. The UE of claim 11, wherein:
the first size of the second quantity of code blocks comprises a first quantity of information bits,
the second size of the third quantity of code blocks comprises a second quantity of information bits, and
the first quantity of information bits is greater than the second quantity of information bits.

22. A method for wireless communications at a user equipment (UE), comprising:
receiving control information comprising a resource allocation for communication of a physical downlink shared channel;
determining a first quantity of code blocks associated with a transport block size of the physical downlink shared channel, wherein the transport block size is based at least in part on the resource allocation;
adjusting the first quantity of code blocks to a second quantity of code blocks based at least in part on a quantity of time and frequency resources allocated for the physical downlink shared channel, a quantity of spatial layers associated with the communication of the physical downlink shared channel, or both; and
communicating, via the quantity of time and frequency resources using the quantity of spatial layers, the second quantity of code blocks in accordance with adjusting the first quantity of code blocks to the second quantity of code blocks.

23. The method of claim 22, wherein adjusting the first quantity of code blocks further comprises:
decreasing the first quantity of code blocks to the second quantity of code blocks such that the quantity of time and frequency resources allocated for the physical downlink shared channel evenly divides a combination of the second quantity of code blocks and the quantity of spatial layer associated with the communication of the physical downlink shared channel.

24. The method of claim 22, wherein adjusting the first quantity of code blocks further comprises:
decreasing the first quantity of code blocks to a third quantity of code blocks; and
increasing, based at least in part on the third quantity of code blocks failing to satisfy a threshold, the first quantity of code blocks to the second quantity of code blocks such that the quantity of time and frequency resources allocated for the physical downlink shared channel evenly divides a combination of the second quantity of code blocks and the quantity of spatial layers associated with the communication of the physical downlink shared channel.

25. The method of claim 22, wherein time resources of the quantity of time and frequency resources span a single orthogonal frequency division multiplexing symbol, wherein each code block of the second quantity of code blocks is divided into two or more code block parts, and wherein communicating the second quantity of code blocks comprises:
communicating each code block part of the second quantity of code blocks via the single orthogonal frequency division multiplexing symbol.

26. The method of claim 22, wherein time resources of the quantity of time and frequency resources span two or more orthogonal frequency division multiplexing symbols, wherein each code block of the second quantity of code blocks is divided into two or more code block parts, and wherein communicating the second quantity of code blocks comprises:
communicating at least a first code block part of a first code block of the second quantity of code blocks via a first orthogonal frequency division multiplexing symbol of the two or more orthogonal frequency division multiplexing symbols; and
communicating at least a second code block part of the first code block via a second orthogonal frequency division multiplexing symbol of the two or more orthogonal frequency division multiplexing symbols.

27. A method for wireless communications at a user equipment (UE), comprising:
receiving control information comprising a resource allocation for communication of a physical downlink shared channel;
determining a first quantity of code blocks associated with a transport block size of the physical downlink shared channel, wherein the transport block size is based at least in part on the resource allocation;
adjusting the first quantity of code blocks to a second quantity of code blocks of a first size, to a third quantity of code blocks of a second size that is less than the first size, or both based at least in part on a quantity of time and frequency resources allocated for the physical downlink shared channel, on the first quantity of code blocks, or both; and
communicating, via the quantity of time and frequency resources using a plurality of spatial layers, the second quantity of code blocks, the third quantity of code blocks, or both in accordance with determining the second quantity of code blocks and determining the third quantity of code blocks.

28. The method of claim 27, further comprising:
adjusting the first quantity of code blocks to the second quantity of code blocks, to the third quantity of code blocks, and to a fourth quantity of code blocks of a third size based at least in part on the first quantity of code blocks, the quantity of time and frequency resources, or both, wherein the third size is less than the first size and greater than the second size; and
communicating, via the quantity of time and frequency resources using a plurality of spatial layers, the fourth quantity of code blocks in accordance with the adjusting.

29. The method of claim 27, wherein time resources of the quantity of time and frequency resources span a single orthogonal frequency division multiplexing symbol, wherein each code block of the second quantity of code blocks, each code block of the third quantity of code blocks, or both are divided into two or more code block parts, and wherein the communicating comprises:
communicating each code block part of the second quantity of code blocks, each code block part of the third quantity of code blocks, or both via the single orthogonal frequency division multiplexing symbol.

30. The method of claim 27, wherein time resources of the quantity of time and frequency resources span two or more orthogonal frequency division multiplexing symbols, wherein each code block of the second quantity of code blocks, each code block of the third quantity of code blocks, or both are divided into two or more code block parts, and wherein the communicating comprises:
communicating each code block part of a first code block of the second quantity of code blocks via the two or more orthogonal frequency division multiplexing symbols, wherein one or more code block parts of the first code block are communicated within a respective orthogonal frequency division multiplexing symbol of the two or more orthogonal frequency division multiplexing symbols; and
communicating each code block part of a first code block of the third quantity of code blocks via the two or more orthogonal frequency division multiplexing symbols, wherein one or more code block parts of the first code block are communicated via a respective orthogonal frequency division multiplexing symbol of the two or more orthogonal frequency division multiplexing symbols.
